(19) United States
(12) Patent Application Publication
(10) Pub. No.: US 2006/0047850 A1
(43) Pub. Date: Mar. 2, 2006

(54) Multi-chassis, multi-path storage solutions in storage area networks

(76) Inventors: Harinder Pal Singh Bhasin, Danville, CA (US); Ambrish Verma, Seattle, WA (US); Shreyas P. Gandhi, Sunnyvale, CA (US); Chao Zhang, Milpitas, CA (US)

Correspondence Address: LAW OFFICES OF BARRY N. YOUNG, 260 SHERIDAN AVENUE, SUITE 410, PALO ALTO, CA, 94306-2047, US

(21) Appl. No.: 10/931,504

(22) Filed: Aug. 31, 2004

(51) Int. Cl. G06F 17/30

(52) U.S. Cl. 709/238; 707/10

(57) ABSTRACT

Systems and methods in accordance with various disclosed embodiments are provided for multi-chassis, multi-pathing solutions in storage area networks. A physical target connected to a first storage switch can be virtualized as a member of a virtual logical unit at a second storage switch to which the physical target is not connected. An inter-chassis link can be provided between the storage switches. If the first storage switch becomes inaccessible, the physical target can be accessed via the second storage switch. A virtual logical unit can also be provisioned at the first switch with a member corresponding to the same physical target. The virtual logical units provisioned at each storage switch can be assigned the same identifier to create a clustered virtual logical unit apparent to host devices. Multiple paths to the same logical unit are thus provided to host devices via either switch.

### CROSS-REFERENCE TO RELATED APPLICATIONS

The following applications are cross-referenced and incorporated by reference herein in their entirety:
U.S. patent application Ser. No. 10/833,438 [Attorney Docket No. MNTI-01009US0], entitled PROACTIVE TRANSFER READY RESOURCE MANAGEMENT IN STORAGE AREA NETWORKS, filed Apr. 28, 2004;
U.S. patent application Ser. No. 10/051,321 [Attorney Docket No. MNTI-01000US1], entitled STORAGE SWITCH FOR STORAGE AREA NETWORK, filed Jan. 18, 2002;
U.S. patent application Ser. No. 10/051,396 [Attorney Docket No. MNTI-01005US0], entitled VIRTUALIZATION IN A STORAGE SYSTEM, filed Jan. 18, 2002; and
U.S. patent application Ser. No. 10/050,974 [Attorney Docket No. MNTI-01007US0], entitled POOLING AND PROVISIONING STORAGE RESOURCES IN A STORAGE NETWORK, filed Jan. 18, 2002.

### BACKGROUND OF THE INVENTION

1. Field of the Invention

The present invention relates generally to storage area networks.

2. Description of the Related Art

The management of information is becoming an increasingly daunting task in today's environment of data intensive industries and applications. More particularly, the management of raw data storage is becoming more cumbersome and difficult as more companies and individuals are faced with larger and larger amounts of data that must be effectively, efficiently, and reliably maintained. Entities continue to face the necessity of adding more storage, servicing more users, and providing access to more data for larger numbers of users.

The concept of storage area networks or SAN's has gained popularity in recent years to meet these increasing demands. Although various definitions of a SAN exist, a SAN can generally be considered a network whose primary purpose is the transfer of data between computer systems and storage elements and among storage elements. A SAN can form an essentially independent network that does not have the same bandwidth limitations as many of its direct-connect counterparts including storage devices connected directly to servers (e.g., with a SCSI connection) and storage devices added directly to a local area network (LAN) using traditional Ethernet interfaces, for example.

In a SAN environment, targets, which can include storage devices (e.g., tape drives and RAID arrays) and other devices capable of storing data, and initiators, which can include servers, personal computing devices, and other devices capable of providing read and write commands, are generally interconnected via various switches and/or appliances. The connections to the switches and appliances are usually Fibre Channel or iSCSI.

A typical appliance may receive and store data within the appliance, then, with an internal processor for example, analyze and operate on the data in order to forward the data to the appropriate target(s). Such store-and-forward processing can slow down data access, including the times for reading data from and writing data to the storage device(s). Accordingly, switches are often used to connect initiators with appliances, given the large number of initiators and small number of ports available in many appliances. In more current SAN implementations, switches have replaced certain functionality previously preformed by appliances such that appliances are not necessary and can be eliminated from the systems.

Some storage area networks provide for increased availability and reliability of data by performing so called mirroring operations whereby multiple copies of data are maintained in the network. These operations typically involve maintaining data associated with a volume in two or more physical devices connected to a single switch to provide redundant access to the data should one target become unavailable. While mirroring data between physical devices at a single switch increases data reliability, there is still an inherent risk that all of the physical devices storing the mirrored data may become unavailable.

Because of the reliance of intermediary devices to perform operations to route data between targets and initiators in storage area networks, there is a risk that target devices and data may become inaccessible because of failures in the communication chain. For example, if a switch becomes unavailable, the storage devices connected to that switch may be unavailable to initiating devices. Moreover, if the data path between a switch and initiator is compromised, the initiator will not have access to the underlying storage devices. Numerous scenarios are possible whereby initiating devices and storage subsystems can lose communication.

Accordingly, there is a need for techniques and systems in storage area networks to address these identified deficiencies and provide for increased availability of physical storage devices and the data maintained thereon.

### SUMMARY OF THE INVENTION

In accordance with embodiments, systems and methods are provided to manage virtual targets for increased availability and reliability of data. Multiple paths to physical targets can be realized by virtualizing physical targets at multiple storage switches. Accordingly, the availability of data residing on the physical targets can be increased.

In accordance with one embodiment, a physical target such as a storage device or storage subsystem can be connected to a first switch. The first switch can be connected to a second switch via one or more inter-chassis links. The physical target can be virtualized at the second switch as a member of a virtual logical unit. A host or initiating device connected to the second switch (and not necessarily the first switch) can access the physical target via the virtual logical unit provisioned at the second switch.

In accordance with one embodiment, the physical target is also provisioned as a remote member of a virtual logical unit at the first storage switch. The virtual logical units provisioned at each switch can be assigned the same identifier to create a clustered virtual logical unit. A host device connected to both switches will have multiple paths to the same logical unit or data store.

In accordance with another embodiment, a mirrored clustered virtual logical unit can be provisioned to provide high availability of data stored in more than one physical location. For example, a first virtual logical unit (VLU) can be provisioned at a first storage switch. The first VLU can include a first member corresponding to one or more physical targets connected to the first switch and a second remote member corresponding to one or more physical targets connected to a second switch. A second VLU can be provisioned at a second storage switch. The second VLU can include a first remote member corresponding to the one or more physical targets connected to the first switch and a second member corresponding to the one or more physical targets connected to the second switch. Each VLU at the switches is provisioned as a mirrored unit so that data written to the VLU is routed to both members of the VLU and thus, to the one or more physical targets at each switch. Each mirrored VLU is also assigned the same identifier to create a mirrored clustered VLU. A host connected to each switch will have multiple paths to the same logical unit and thus, the one or more physical devices connected to both switches. If one of the switches becomes unavailable, the host can access the data via the remaining switch and physical device(s) connected thereto, since the data on each physical target is the same by virtue of mirroring.

In one embodiment, a first storage switch for accessing virtual targets is provided that includes at least one virtual logical unit configuration including at least one member associated with at least one physical target coupled to a different storage switch and a communications link to said different storage switch. The at least one member can be at least one first remote member and the at least one virtual logical unit configuration can further include a second member associated with at least one second physical target coupled to the first storage switch. In one embodiment, the at least one virtual logical unit configuration can be provisioned as a mirrored virtual logical unit configuration with the at least one first remote member and the second member as mirrored members of the mirrored virtual logical unit configuration.

In one embodiment, a method (or one or more processor readable storage devices having code that when executed by one or more processors performs the method) for provisioning virtual targets is provided that comprises provisioning at a first device a member corresponding to at least one physical target coupled to a second device, and provisioning at the first device a virtual logical unit configuration including the first member. The member can be a first remote member and the method can further include provisioning at the first device a second member corresponding to at least one second physical target coupled to the first device. In such a case, provisioning at the first device a virtual logical unit configuration can include provisioning the virtual logical unit configuration to include the second member. In one embodiment, the virtual logical unit configuration can be a mirrored configuration.

In one embodiment, a system for accessing virtual targets is provided that includes a clustered virtual logical unit including at least one first virtual logical unit provisioned at a first storage switch and at least one second virtual logical unit provisioned at a second storage switch, wherein the first virtual logical unit and the second virtual logical unit have the same logical unit identifier. The first virtual logical unit can include a first member associated with at least a first physical target coupled to the first storage switch, and the second virtual logical unit can include a first remote member associated with the at least a first physical target coupled to the first storage switch. The second virtual logical unit can further include a second member associated with at least a second physical target coupled to the second storage switch and the second virtual logical unit can include a second remote member associated with the at least a second physical target coupled to the second storage switch. In such a case, the first virtual logical unit can be made a mirrored virtual logical unit with the first member and the second remote member as mirrored members. The second virtual logical unit can be made a mirrored virtual logical unit with the second member and the first remote member as mirrored members of the second virtual logical unit. The first member and the first remote member represent the virtualization of the same physical storage at the two devices and the second member and the second remote member represent the virtualization of the same physical storage at the two devices.

In yet another embodiment, a method (or one or more processor readable storage devices having code that when executed by one or more processors performs the method) of accessing virtual targets is provided that includes provisioning a first virtual logical unit at a first storage switch, associating the first virtual logical unit with a logical unit identifier, provisioning a second virtual logical unit at a second storage switch, and associating the second virtual logical unit with the same logical unit identifier. The method can further include provisioning at the first storage switch a first member corresponding to at least one physical target coupled to the first storage switch, and provisioning at the second storage switch a first remote member corresponding to the at least one physical target. The step of provisioning a first virtual logical unit can include provisioning the first member as a member of the first virtual logical unit and the step of provisioning a second virtual logical unit can include provisioning the first remote member as a member of the second virtual logical unit.

In one embodiment, the method can further include provisioning at the first storage switch a second remote member corresponding to at least one second physical target coupled to the second storage switch and provisioning at the second storage switch a second member corresponding to the at least one second physical target. The step of provisioning a first virtual logical unit can include provisioning the second remote member as a member of the first virtual logical unit and the step of provisioning a second virtual logical unit can include provisioning the second member as a member of the second virtual logical unit. In one embodiment, the step of provisioning a first virtual logical unit includes provisioning the first virtual logical unit as a mirrored virtual logical unit having the first member and the second remote member as mirrored members and the step of provisioning a second virtual logical unit includes provisioning the second virtual logical mirrored virtual logical unit having the first remote member and the second member as mirrored members.

The present invention can be accomplished using hardware, software, or a combination of both hardware and software. The software used for the present invention is stored on one or more processor readable storage devices including hard disk drives, CD-ROMs, DVDs, optical disks, floppy disks, tape drives, RAM, ROM, flash memory or other suitable storage devices. In alternative embodiments, some or all of the software can be replaced by dedicated hardware including custom integrated circuits, gate arrays, FPGAs, PLDs, and special purpose processors. In one embodiment, software implementing the present invention is used to program one or more processors. The one or more processors can be in communication with one or more storage devices (hard disk drives, CD-ROMs, DVDs, optical disks, floppy disks, tape drives, RAM, ROM, flash memory or other suitable storage devices), peripherals (printers, monitors, keyboards, pointing devices) and/or communication interfaces (e.g. network cards, wireless transmitters/receivers, etc.).

Other features, aspects, and objects of the invention can be obtained from a review of the specification, the figures, and the claims.

### BRIEF DESCRIPTION OF THE DRAWINGS

FIG. 1 is a generalized functional block diagram of a storage area network in accordance with one embodiment;

FIG. 2 is a generalized functional block diagram of a storage switch in accordance with one embodiment;

FIG. 3 is a generalized functional block diagram of a linecard used in a storage switch in accordance with one embodiment;

FIG. 4 is a generalized functional block diagram illustrating virtual targets as can be seen by an initiating device;

FIGS. 5a-5c are generalized functional block diagrams of a storage area network illustrating an exemplary provisioning of virtual targets;

FIG. 6a is a flowchart depicting a classification process of iSCSI packets in the ingress direction as the process occurs in a PACE in accordance with one embodiment;

FIG. 6b is a flowchart depicting a classification process of iSCSI packets in the egress direction as the process occurs in a PACE in accordance with one embodiment;

FIG. 7a is a flowchart depicting a classification process of FCP frames in the ingress direction as the process occurs in a PACE in accordance with one embodiment;

FIG. 7b is a flowchart depicting a classification process of FCP frames in the egress direction as the process occurs in a PACE in accordance with one embodiment;

FIG. 8a is a flowchart depicting a classification process in the ingress direction as the process occurs in a PPU in accordance with one embodiment;

FIG. 8b is a flowchart depicting a classification process in the egress direction as the process occurs in a PPU in accordance with one embodiment;

FIG. 9a is a flowchart illustrating a virtualization process in the ingress direction for command packets or frames, in accordance with one embodiment;

FIG. 9b is a flowchart illustrating a virtualization process in the egress direction for command packets or frames, in accordance with one embodiment;

FIG. 10a is a flowchart illustrating a virtualization process in the ingress direction for R2T or XFER_RDY packets or frames, in accordance with one embodiment;

FIG. 10b is a flowchart illustrating a virtualization process in the egress direction for R2T or XFER_RDY packets or frames, in accordance with one embodiment;

FIG. 11a is a flowchart illustrating a virtualization process in the ingress direction for write data packets or frames, in accordance with one embodiment;

FIG. 11b is a flowchart illustrating a virtualization process in the egress direction for write data packets or frames, in accordance with one embodiment;

FIG. 12 is a block diagram depicting a storage area network in accordance with one embodiment;

FIG. 13 is a block diagram depicting a storage area network in accordance with one embodiment;

FIG. 14 is a flowchart depicting a provisioning process for a clustered virtual logical unit in accordance with one embodiment;

FIG. 15 is flowchart depicting a process for provisioning a member at a first switch for physical storage connected to a second switch;

FIG. 16 is a block diagram depicting a write data flow in the storage area network of FIG. 13 in accordance with one embodiment.

FIG. 17 is a flowchart depicting a write operation in a storage area network in accordance with one embodiment;

FIG. 18 is a block diagram depicting a write data flow for the storage network of FIG. 16 in accordance with one embodiment;

FIG. 19 is a block diagram of a storage area network in accordance with one embodiment;

FIG. 20 is a block diagram of a storage area network depicting a message passing architecture;

FIG. 21 is a flowchart depicting an exemplary control command flow for a message passing architecture; and

FIG. 22 is a flowchart depicting an exemplary control command flow for a message passing architecture.

### DETAILED DESCRIPTION

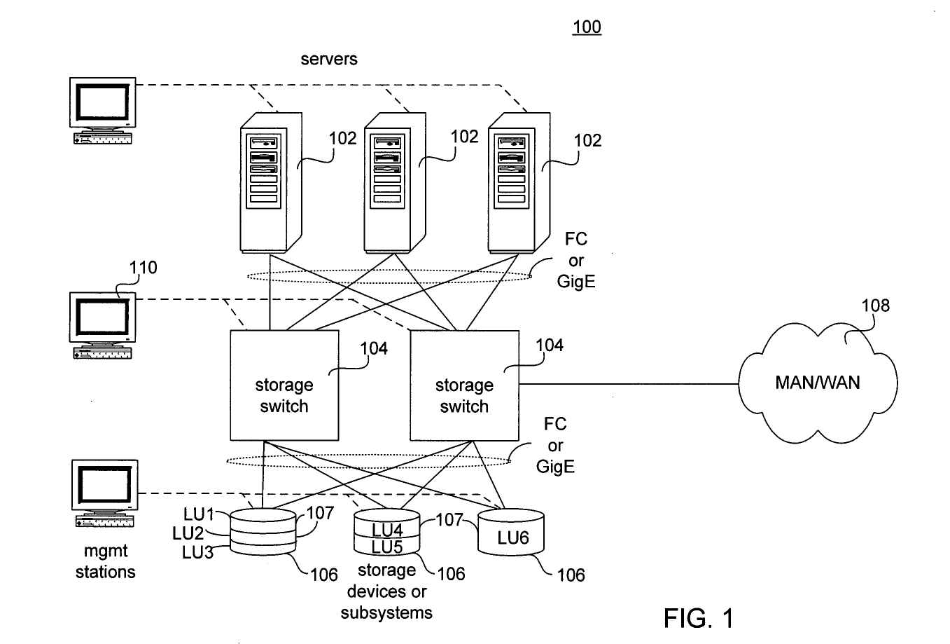

An exemplary system 100 including a storage switch in accordance with one embodiment is illustrated in FIG. 1. System 100 can include a plurality of initiating devices such as servers 102. It will be appreciated that more or fewer servers can be used and that embodiments can include any suitable physical initiator in addition to or in place of servers 102. Although not shown, the servers could also be coupled to a LAN. As shown, each server 102 is connected to a storage switch 104. In other embodiments, however, each server 102 may be connected to fewer than all of the storage switches 104 present. The connections formed between the servers and switches can utilize any protocol, although in one embodiment the connections are Fibre Channel or Gigabit Ethernet (carrying packets in accordance with the iSCSI protocol). Other embodiments may use the Infiniband protocol, defined by the Infiniband Trade Association, or other protocols or connections.

In some embodiments, one or more switches 104 are each coupled to a Metropolitan Area Network (MAN) or Wide Area Network (WAN) 108, such as the Internet. The connection formed between a storage switch 104 and a WAN 108 will generally use the Internet Protocol (IP) in most embodiments. Although shown as directly connected to MAN/WAN 108, other embodiments may utilize a router (not shown) as an intermediary between switch 104 and MAN/WAN 108.

In addition, respective management stations 110 are connected to each storage switch 104, to each server 102, and to each storage device 106. Although management stations are illustrated as distinct computers, it is to be understood that the software to manage each type of device could collectively be on a single computer.

Such a storage switch 104, in addition to its switching function, can provide virtualization and storage services (e.g., mirroring). Such services can include those that would typically be provided by appliances in conventional architectures.

In addition, the intelligence of a storage switch in accordance with an embodiment of the invention is distributed to every switch port. This distributed intelligence allows for system scalability and availability. The distributed intelligence allows a switch in accordance with an embodiment to process data at “wire speed,” meaning that a storage switch 104 introduces no more latency to a data packet than would be introduced by a typical network switch. Thus, “wire speed” for the switch is measured by the connection to the particular port. Accordingly, in one embodiment having OC-48 connections, the storage switch can keep up with an OC-48 speed (2.5 bits per ns). A two Kilobyte packet (with 10 bits per byte) moving at OC-48 speed can take as little as eight microseconds coming into the switch. A one Kilobyte packet can take as little as four microseconds. A minimum packet of 100 bytes can only elapse a mere 400 ns.

More information on various storage area networks, including a network as illustrated in FIG. 1 can be found in U.S. patent application Ser. No. 10/051,396, entitled VIRTUALIZATION IN A STORAGE SYSTEM, filed Jan. 18, 2002 and U.S. patent application Ser. No. 10/051,321, entitled STORAGE SWITCH FOR STORAGE AREA NETWORK, filed Jan. 18, 2002.

“Virtualization” generally refers to the mapping of a virtual target space subscribed to by a user to a space on one or more physical storage target devices. The terms “virtual” and “virtual target” (or “virtual logical unit”) come from the fact that storage space allocated per subscription can be anywhere on one or more physical storage target devices connecting to a storage switch 104. The physical space can be provisioned as a “virtual target” or “virtual logical unit (VLU)” which may include one or more “logical units” (LUs). Each virtual target consists of one or more LUs identified with one or more LU numbers (LUNs), which are frequently used in the iSCSI and FC protocols. Each logical unit is generally comprised of one or more extents—a contiguous slice of storage space on a physical device. Thus, a virtual target or VLU may occupy a whole storage device (one extent), a part of a single storage device (one or more extents), or parts of multiple storage devices (multiple extents). The physical devices, the LUs, the number of extents, and their exact locations are immaterial and invisible to a subscriber user.

Storage space may come from a number of different physical devices, with each virtual target belonging to one or more “pools” in various embodiments, sometimes referred to herein as “domains.” Only users of the same domain are allowed to share the virtual targets in their domain in one embodiment. Domain-sets can also be formed that include several domains as members. Use of domain-sets can ease the management of users of multiple domains, e.g., if one company has five domains but elects to discontinue service, only one action need be taken to disable the domain-set as a whole. The members of a domain-set can be members of other domains as well.

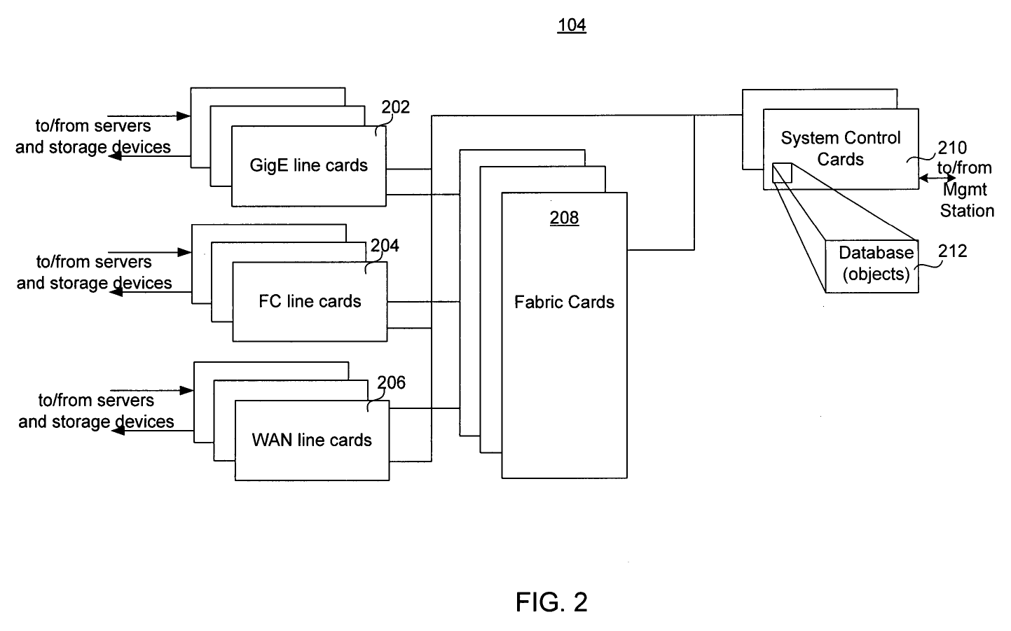

FIG. 2 illustrates a functional block diagram of a storage switch 104 in accordance with an embodiment of the invention. More information regarding the details of a storage switch such as storage switch 104 and its operation can be found in U.S. patent application Ser. No. 10/051,321, entitled STORAGE SWITCH FOR STORAGE AREA NETWORK, filed Jan. 18, 2002. In one embodiment, the storage switch 104 includes a plurality of linecards 202, 204, and 206, a plurality of fabric cards 208, and two system control cards 210, each of which will be described in further detail below. Although an exemplary storage switch is illustrated, it will be appreciated that numerous other implementations and configurations can be used in accordance with various embodiments.

System Control Cards. Each of the two System Control Cards (SCCs) 210 connects to every line card 202, 204, 206. In one embodiment, such connections are formed by I²C signals, which are well known in the art, and through an Ethernet connection with the SCC. The SCC controls power up and monitors individual linecards, as well as the fabric cards, with the I²C connections. Using inter-card communication over the Ethernet connections, the SCC also initiates various storage services, e.g., snapshot and replicate.

In addition, the SCC maintains a database 212 that tracks configuration information for the storage switch as well as all virtual targets and physical devices attached to the switch, e.g., servers and storage devices. In addition, the database keeps information regarding usage, error and access data, as well as information regarding different domains and domain sets of virtual targets and users. The records of the database may be referred to herein as “objects.” Each initiator (e.g., a server) and target (e.g., a storage device) has a World Wide Unique Identifier (WWUI), which are known in the art. The database is maintained in a memory device within the SCC, which in one embodiment is formed from flash memory, although other memory devices can be used in various embodiments.

The storage switch 104 can be reached by a management station 110 through the SCC 210 using an Ethernet connection. Accordingly, the SCC also includes an additional Ethernet port for connection to a management station. An administrator at the management station can discover the addition or removal of storage devices or virtual targets, as well as query and update virtually any object stored in the SCC database 212.

Fabric Cards. In one embodiment of switch 104, there are three fabric cards 208, although other embodiments could have more or fewer fabric cards. Each fabric card 208 is coupled to each of the linecards 202, 204, 206 in one embodiment and serves to connect all of the linecards together. In one embodiment, the fabric cards 208 can each handle maximum traffic when all linecards are populated. Such traffic loads handled by each linecard are up to 160 Gbps in one embodiment although other embodiments could handle higher or lower maximum traffic volumes. If one fabric card 208 fails, the two surviving cards still have enough bandwidth for the maximum possible switch traffic: in one embodiment, each linecard generates 20 Gbps of traffic, 10 Gbps ingress and 10 Gbps egress. However, under normal circumstances, all three fabric cards are active at the same time. From each linecard, the data traffic is sent to any one of the three fabric cards that can accommodate the data.

Linecards. The linecards form connections to servers and to storage devices. In one embodiment, storage switch 104 supports up to sixteen linecards although other embodiments could support a different number. Further, in one embodiment, three different types of linecards are utilized: Gigabit Ethernet (GigE) cards 202, Fibre Channel (FC) cards 204, and WAN cards 206. Other embodiments may include more or fewer types of linecards. The GigE cards 202 are for Ethernet connections, connecting in one embodiment to either iSCSI servers or iSCSI storage devices (or other Ethernet based devices). The FC cards 204 are for Fibre Channel connections, connecting to either Fibre Channel Protocol (FCP) servers or FCP storage devices. The WAN cards 206 are for connecting to a MAN or WAN.

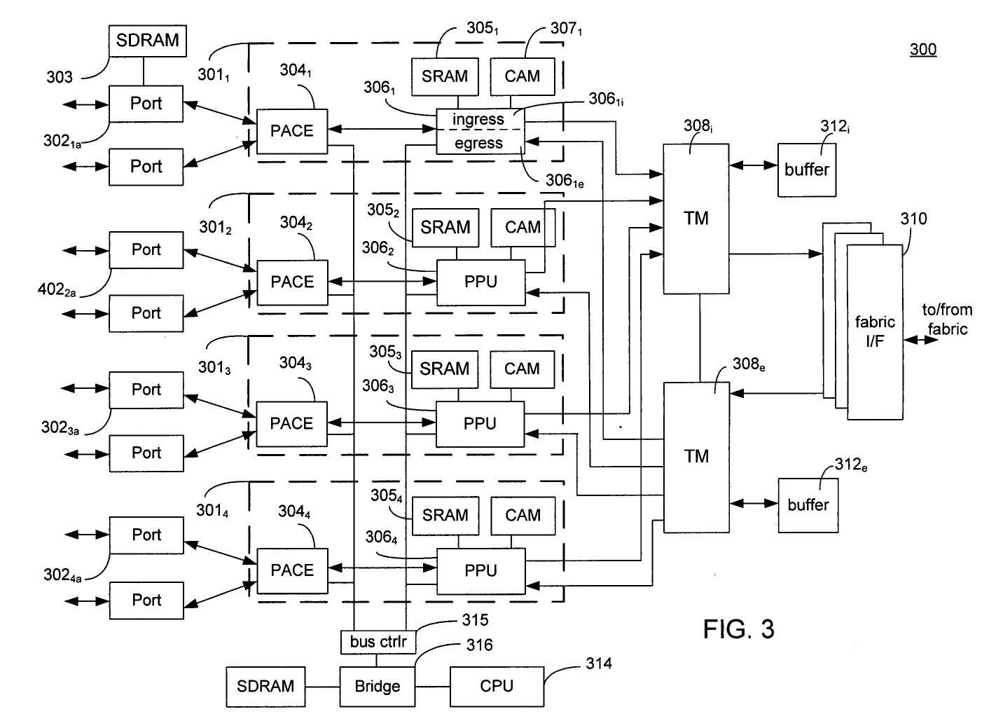

FIG. 3 illustrates a functional block diagram of a generic line card 300 used in a storage switch 104 in accordance with one embodiment. Line card 300 is presented for exemplary purposes only. Other line cards and designs can be used in accordance with embodiments. The illustration shows those components that are common among all types of linecards, e.g., GigE 302, FC 304, or WAN 306. In other embodiments other types of linecards can be utilized to connect to devices using other protocols, such as Infiniband.

Ports. Each line card 300 includes a plurality of ports 302. The ports form the linecard's connections to either servers or storage devices. Eight ports are shown in the embodiment illustrated, but more or fewer could be used in other embodiments. For example, in one embodiment each GigE card can support up to eight 1 Gb Ethernet ports, each FC card can support up to either eight 1 Gb FC ports or four 2 Gb FC ports, and each WAN card can support up to four OC-48 ports or two OC-192 ports. Thus, in one embodiment, the maximum possible connections are 128 ports per switch 104. The ports of each linecard are full duplex in one embodiment, and connect to either a server or other client, and/or to a storage device or subsystem.

In addition, each port 302 has an associated memory 303. Although only one memory device is shown connected to one port, it is to be understood that each port may have its own memory device or the ports may all be coupled to a single memory device. Only one memory device is shown here coupled to one port for clarity of illustration.

Storage Processor Unit. In one embodiment, each port is associated with a Storage Processor Unit (SPU) 301. In one embodiment the SPU rapidly processes the data traffic allowing for wire-speed operations. In one embodiment, each SPU includes several elements: a Packet Aggregation and Classification Engine (PACE) 304, a Packet Processing Unit (PPU) 306, an SRAM 305, and a CAM 307. Still other embodiments may use more or fewer elements or could combine elements to obtain the same functionality. For instance, some embodiments may include a PACE and a PPU in the SPU, but the SPU may share memory elements with other SPUs.

PACE. Each port is coupled to a Packet Aggregation and Classification Engine (PACE) 304. As illustrated, the PACE 304 aggregates two ports into a single data channel having twice the bandwidth. For instance, the PACE 304 aggregates two 1 Gb ports into a single 2 Gb data channel. The PACE can classify each received packet into a control packet or a data packet. Control packets are sent to the CPU 314 for processing, via bridge 316. Data packets are sent to a Packet Processing Unit (PPU) 306, discussed below, with a local header added. In one embodiment the local header is sixteen bytes resulting in a data “cell” of 64 bytes (16 bytes of header and 48 bytes of payload). The local header is used to carry information and used internally by switch 104. The local header is removed before the packet leaves the switch. Accordingly, a “cell” can be a transport unit used locally in the switch that includes a local header and the original packet (in some embodiments, the original TCP/IP headers are also stripped from the original packet). Nonetheless, not all embodiments of the invention will create a local header or have “internal packets” (cells) that differ from external packets. Accordingly, the term “packet” as used herein can refer to either “internal” or “external” packets.

The classification function helps to enable a switch to perform storage virtualization and protocol translation functions at wire speed without using a store-and-forward model of conventional systems. Each PACE has a dedicated path to a PPU, e.g. PPU 3061, while all four PACEs in the illustrated embodiment share a path to the CPU 314, which in one embodiment is a 104 MHz/32 (3.2 Gbps) bit data path.

Packet Processing Unit (PPU). Each PPU such as PPU 306, performs virtualization and protocol translation on-the-fly, meaning that cells are not buffered for such processing. It also implements other switch-based storage service functions, described later. The PPU is capable, in one embodiment, of moving cells at OC-48 speed or 2.5 Gbps for both the ingress and egress directions, while in other embodiments it can move cells at OC-192 speeds or 10 Gbps. The PPU in one embodiment includes an ingress PPU 306₁ᵢ and an egress PPU 306₁ₑ, which both run concurrently. The ingress PPU 306₁ᵢ receives incoming data from PACE 304₁ and sends data to the Traffic Manager 308ᵢ while the egress PPU 306₁ₑ receives data from Traffic Manager 308e and sends data to a PACE 304₁. Although only one PPU 306₁ is shown in FIG. 3 as having an ingress PPU 306₁ᵢ and an egress PPU 306₁ₑ, it is to be understood that in one embodiment all PPUs 306 will include both an ingress and an egress PPU and that only one PPU is shown in FIG. 3 with both ingress and egress PPUs for clarity of illustration.

A large number of storage connections (e.g., server to virtual target) can be established concurrently at each port. Nonetheless, each connection is unique to a virtual target and can be uniquely identified by a TCP Control Block Index (in the case of iSCSI connections) and a port number. When a connection is established, the CPU 314 of the linecard 300 informs a PPU 306 of an active virtual target by sending it a Virtual Target Descriptor (VTD) for the connection. The VTD includes all relevant information regarding the connection and virtual target that the PPU will need to properly operate on the data, e.g., perform virtualization, translation, and various storage services. The VTD is derived from an object in the SCC database and usually contains a subset of information that is stored in the associated object in the SCC database.

Similarly, Physical Target Descriptors (PTDs) are utilized in an embodiment of the invention. PTDs describe the actual physical devices, their individual LUs, or their individual extents (a contiguous part of or whole LU) and will include information similar to that for the VTD. Also, like the VTD, the PTD is derived from an object in the SCC database.

To store the VTDs and PTDs and have quick access to them, in one embodiment the PPUs such as PPU 306₁ are connected to an SRAM 305₁ and CAM 307₁. SRAM 305₁ can store a VTD and PTD database. A listing of VTD Identifiers (VTD IDs), or addresses, as well as PTD Identifiers (PTD IDs), is also maintained in the PPU CAM 307₁ for quick accessing of the VTDs. The VTD IDs are indexed (mapped) using a TCP Control Block Index and a LUN. The PTD IDs are indexed using a VTD ID. In addition, for IP routing services, the CAM 307, contains a route table, which is updated by the CPU when routes are added or removed.

In various embodiments, each PPU will be connected with its own CAM and SRAM device as illustrated, or the PPUs will all be connected to a single CAM and/or SRAM (not illustrated).

For each outstanding request to the PPU (e.g., reads or writes), a task control block is established in the PPU SRAM 307 to track the status of the request. There are ingress task control blocks (ITCBs) tracking the status of requests received by the storage switch on the ingress PPU and egress task control blocks (ETCBs) tracking the status of requests sent out by the storage switch on the egress PPU. For each virtual target connection, there can be a large number of concurrent requests, and thus many task control blocks. Task control blocks are allocated as a request begins and freed as the request completes.

Traffic Manager. There are two traffic managers (TMs) 308 on each linecard 300: one TM 308ᵢ for ingress traffic and one TM 308ₑ for egress traffic. The ingress TM receives cells from all four SPUs, in the form of 64-byte data cells, in one embodiment. In such an embodiment, each data cell has 16 bytes of local header and 48 bytes of payload. The header contains a Flow ID that tells the TM the destination port of the cell. In some embodiments, the SPU may also attach a TM header to the cell prior to forwarding the cell to the TM. Either the TM or the SPU can also subdivide the cell into smaller cells for transmission through the fabric cards in some embodiments.

The ingress TM sends data cells to the fabric cards via a 128-bit 104 Mhz interface 310 in one embodiment. Other embodiments may operate at 125 Mhz or other speeds. The egress TM receives the data cells from the fabric cards and delivers them to the four SPUs.

Both ingress and egress TMs have a large buffer 312 to queue cells for delivery. Both buffers 312 for the ingress and egress TMs are 64 MB, which can queue a large number of packets for internal flow control within the switch. The cells are not buffered as in cached or buffered switch implementations. There is no transport level acknowledgement as in these systems. The cells are only temporarily buffered to maintain flow control within the switch. The cells maintain their original order and there is no level high level processing of the cells at the TM The SPUs can normally send cells to the ingress TM quickly as the outgoing flow of the fabric cards is as fast as the incoming flow. Hence, the cells are moving to the egress TM quickly. On the other hand, an egress TM may be backed up because the outgoing port is jammed or being fed by multiple ingress linecards. In such a case, a flag is set in the header of the outgoing cells to inform the egress SPU to take actions quickly. The egress TM also sends a request to the ingress SPU to activate a flow control function used in providing Quality of Service for Storage access. It is worth noting that, unlike communications traffic over the Internet, for storage traffic dropping a packet or cell is unacceptable. Therefore, as soon as the amount of cells in the buffer exceeds a specified threshold, the SPU can activate its flow control function to slow down the incoming traffic to avoid buffer overflow.

Fabric Connection. The fabric connection 310 converts the 256-bit parallel signals of the TM (128 bits ingress and 128 bits egress, respectively), into a 16-bit serial interface (8-bit ingress and 8-bit egress) to the backplane at 160 Gbps. Thus the backplane is running at one sixteenth of the pins but sixteen times faster in speed. This conversion enables the construction of a high availability backplane at a reasonable cost without thousands of connecting pins and wires. Further, because there are three fabric cards in one embodiment, there are three high-speed connectors on each linecard in one embodiment, wherein the connectors each respectively connect the 8-bit signals to a respective one of the three fabric cards. Of course, other embodiments may not require three fabric connections 310.

CPU. On every linecard there is a processor (CPU) 614, which in one embodiment is a PowerPC 750 Cxe. In one embodiment, CPU 314 connects to each PACE with a 3.2 Gb bus, via a bus controller 315 and a bridge 316. In addition, CPU 314 also connects to each PPU, CAM and TM, however, in some embodiments this connection is slower at 40 Mbps. Both the 3.2 Gb and 40 Mb paths allow the CPU to communicate with most devices in the linecard as well as to read and write the internal registers of every device on the linecard, download microcode, and send and receive control packets.

The CPU on each linecard is responsible to initialize every chip at power up and to download microcode to the SPUs and each port wherever the microcode is needed. Once the linecard is in running state, the CPU processes the control traffic. For information needed to establish a virtual target connection, the CPU requests the information from the SCC, which in turn gets the information from an appropriate object in the SCC database.

Distinction in Linecards—Ports. The ports in each type of linecard, e.g., GigE, FC, or WAN are distinct as each linecard supports one type of port in one embodiment. In other embodiments, other linecard ports could be designed to support other protocols, such as Infiniband.

GigE Port. A gigabit Ethernet port connects to iSCSI servers and storage devices. While the GigE port carries all kinds of Ethernet traffic, the only network traffic generally to be processed by a storage switch 104 at wire speed in accordance with one embodiment of the invention is an iSCSI Packet Data Unit (PDU) inside a TCP/IP packet. Nonetheless, in other embodiments packets in accordance with other protocols (like Network File System (NFS)) carried over Ethernet connections may be received at the GigE Port and processed by the SPU and/or CPU.

The GigE port receives and transmits TCP/IP segments for virtual targets or iSCSI devices. To establish a TCP connection for a virtual target, both the linecard CPU 314 and the SCC 310 are involved. When a TCP packet is received, and after initial handshaking is performed, a TCP control block is created and stored in the GigE port memory 303. A VTD is also retrieved from an object of the SCC database and stored in the CPU SDRAM 305 for the purpose of authenticating the connection and understanding the configuration of the virtual target. The TCP Control Block identifies a particular TCP session or iSCSI connection to which the packet belongs, and contains in one embodiment, TCP segment numbers, states, window size, and potentially other information about the connection. In addition, the TCP Control Block is identified by an index, referred to herein as the “TCP Control Block Index.” A VTD for the connection can be created and stored in the SPU SRAM 305. The CPU creates the VTD by retrieving the VTD information stored in its SDRAM and originally obtained from the SCC database. A VTD ID is established in a list of VTD IDs in the SPU CAM 307 for quick reference to the VTD. The VTD ID is affiliated with and indexed by the TCP Control Block Index.

When the port receives iSCSI PDUs, it serves essentially as a termination point for the connection, but then the switch initiates a new connection with the target. After receiving a packet on the ingress side, the port delivers the iSCSI PDU to the PACE with a TCP Control Block Index, identifying a specific TCP connection. For a non-TCP packet or a TCP packet not containing an iSCSI PDU, the port receives and transmits the packet without acting as a termination point for the connection. Typically, the port 302 communicates with the PACE 304 that an iSCSI packet is received or sent by using a TCP Control Block Index. When the TCP Control Block Index of a packet is −1, it identifies a non-iSCSI packet.

FC Port. An FC port connects to servers and FC storage devices. The FC port appears as a fibre channel storage subsystem (i.e., a target) to the connecting servers, meaning, it presents a large pool of virtual target devices that allow the initiators (e.g., servers) to perform a Process Login (PLOGI or PRLI), as are understood in the art, to establish a connection. The FC port accepts the GID extended link services (ELSs) and returns a list of target devices available for access by that initiator (e.g., server).

When connecting to fibre channel storage devices, the port appears as a fibre channel F-port, meaning, it accepts a Fabric Login, as is known in the art, from the storage devices and provides name service functions by accepting and processing the GID requests—in other words, the port will appear as an initiator to storage devices.

In addition, an FC port can connect to another existing SAN network, appearing in such instances as a target with many LUs to the other network.

At the port initialization, the linecard CPU can go through both sending Fabric Logins, Process Logins, and GIDs as well as receive the same. The SCC supports an application to convert FC ELS's to iSNS requests and responses. As a result, the same database in the SCC keeps track of both the FC initiators (e.g., servers) and targets (e.g., storage devices) as if they were iSCSI initiators and targets.

When establishing an FC connection, unlike for a GigE port, an FC port does not need to create TCP control blocks or their equivalent; all the necessary information is available from the FC header. But, a VTD (indexed by a D_ID which identifies the destination of a frame) will still need to be established in a manner similar to that described for the GigE port.

An FC port can be configured for 1 Gb or 2 Gb. As a 1 Gb port, two ports are connected to a single PACE as illustrated in FIG. 3; but in an embodiment where it is configured as a 2 Gb port, port traffic and traffic that can be accommodated by the SPU should match to avoid congestion at the SPU. The port connects to the PACE with a POS/PHY interface in one embodiment. Each port can be configured separately, i.e. one PACE may have two 1 Gb ports and another PACE has a single 2 Gb port.

WAN Ports. In embodiments that include a WAN linecard, the WAN linecard supports OC-48 and OC-192 connections in one embodiment. Accordingly, there are two types of WAN ports: OC-48 and OC-192. For OC-48, there is one port for each SPU. There is no aggregation function in the PACE, although there still is the classification function. A WAN port connects to SONET and works like a GigE port as it transmits and receives network packets such as ICMP, RIP, BPG, IP and TCP. A WAN port in one embodiment supports network security with VPN and IPSec that requires additional hardware components.

Since OC-192 results in a faster wire speed, a faster SPU will be required in embodiments that support OC-192.

Switch-Based Storage Operations

One of ordinary skill in the art will have a general knowledge of the iSCSI and FC protocols. However, for more information on iSCSI refer to “draft-ietf-ips-iSCSI-20.txt,” an Internet Draft (see www.ietf.org) and work in progress by the Internet Engineering Task Force (IETF), Jan. 19, 2003, incorporated herein by reference in its entirety. For more information about Fibre Channel (FC) refer to “SCSI Fibre Channel Protocol—2 (FCP-2)”, Nov. 23, 2002, Rev: 08 (see www.t10.org), incorporated herein by reference in its entirety. In addition, both are further described in U.S. patent application Ser. No. 10/051,321, entitled STORAGE SWITCH FOR STORAGE AREA NETWORK, filed Jan. 18, 2002.

Storage Pools

As shown in FIG. 1, in its physical configuration, a system in accordance with an embodiment of the invention includes a switch 104 coupled to one or more servers 102 and to one or more physical devices 106, i.e., storage devices or subsystems. Each physical target is comprised of one or more logical units (LUs) 107. It is from these LUs that virtual targets or VLUs will ultimately be formed.

Before a virtual target can be created, or “provisioned,” the switch needs to be “aware” of the physical storage devices attached and/or available for access by it as well as the characteristics of those physical storage devices. Accordingly, in one embodiment of the invention, when a storage device or an initiator device is connected to or registered with the switch, the switch must learn about the performance characteristics of the new device. Once a device is “discovered,” various inquiries are sent to the device to gather information regarding performance characteristics. For instance, read/write commands can be sent to measure transfer rate or to check access time. Alternatively, in some embodiments, the obtaining of performance characteristics can be done by having an administrator enter the performance characteristics at a management station 110, wherein the characteristics can then be provided to a switch 104.

Based on the information gathered about the device, all of which is generally invisible to the end user, in one embodiment of the invention the switch classifies the device based on a policy. Once a policy has been determined for a storage device, the LUs for the device are assigned to a storage pool 802, sometimes referred to herein as a “domain.” Since each storage device is comprised of one or more LUs, all the LUs of a particular storage device are assigned to the same pool. However, in one embodiment, each LU is considered by the switch as a separate storage node and each LU is described by an LU object in the SCC database. Thus, each pool has as members the LUs. In one embodiment, assignment to a pool is done independent of the protocol under which the physical storage device operates, e.g., iSCSI or Fiber Channel. As will be understood by those of skill in the art, each pool is defined in a switch by a listing for the pool of the LUs assigned to it, which listing is stored in the SCC database in one embodiment. Such a listing may be comprised of pointers to the LU objects.

Generally each pool will be accessible only to users with particular characteristics. For example, a storage pool may be established for those users located in a Building 1, where the pool is entitled “Building 1 Shared Gold Storage Pool.” Another exemplary pool may be entitled “Engineering Exclusive Silver Storage Pool” and may be exclusively accessible by the engineering team at a particular company. Of course an infinite variation of pools could be established and those described and illustrated are exemplary only.

In addition, in an embodiment, there are two special pools: a “Default Pool” and a “No Pool.” A Default Pool allows access to anyone with access to the storage network. A “No Pool,” in contrast, is not generally accessible to users and is only accessible to the switch itself or to the system administrator. Once assigned to a pool, the LUs can be reassigned to different pools by the switch itself or by a system administrator. For instance, an LU may initially be placed in the No Pool, tested, and then later moved to the default pool or other pool.

Provisioning a Virtual Target

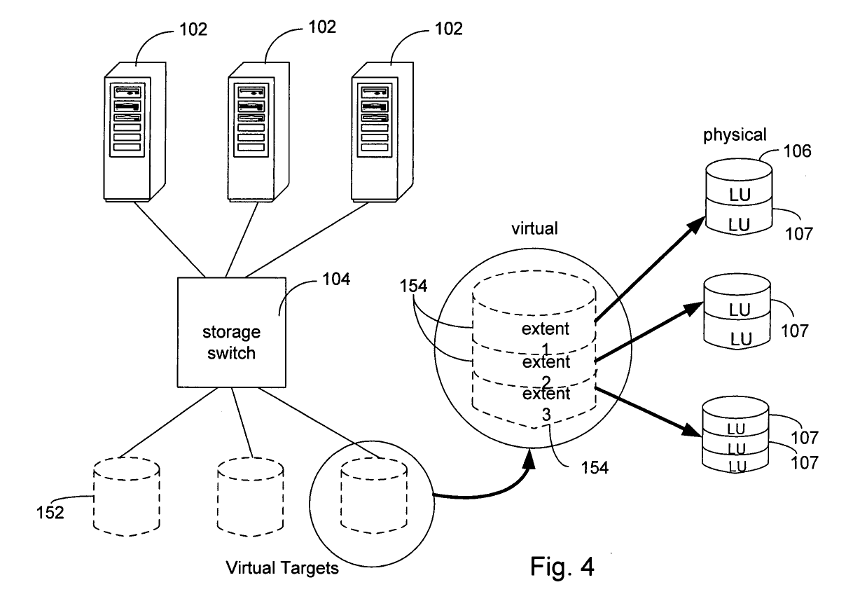

Once the LUs for physical devices are in an accessible pool (i.e., not the “No Pool”), then a virtual target or VLU can be created from those LUs. Once created, as shown in FIG. 4, the servers (and their respective users) will “see” one or more virtual targets or VLUs 152, each comprised of one or more extents 154, but they will not necessarily “see” the physical devices 106. An extent is a contiguous part of or a whole LU from a physical device. As shown in the example of FIG. 4, each extent in the example virtual target 152 is formed from entire LUs from several physical devices. “Extent” may still be referenced by an LUN from an initiator, such as a server, which doesn't realize a target is “virtual.” The composition of the virtual targets, including protocols used by the LU is irrelevant to the server. However, as shown in FIG. 4, each virtual target is comprised of extents that map to the LUs of physical devices 106.

To provision a virtual target, a user selects several characteristics for the virtual target in one embodiment including:
the size (e.g., in Gigabytes);
a storage pool, although in one embodiment the user may select only from the storage pools which the user is permitted to access;
desired availability, e.g., always available (data is critical and must not ever go down), usually available, etc.;
the WWUI of the virtual target;
a backup pool;
user authentication data;
number of mirrored members;
locations of mirrored numbers (e.g., local or remote).
   Still in other embodiments of the invention, different, additional, or fewer characteristics can also be selected.

The switch then analyzes the available resources from the selected pool to determine if the virtual target can be formed, and in particular the switch determines if a number of LUs (or parts of LUs) to meet the size requirement for the virtual target are available. If so, the virtual target is created with one or more extents and a virtual target object is formed in the SCC database identifying the virtual target, its extents, and its characteristics. Examples of user-selected characteristics for various virtual targets can be found in U.S. patent application Ser. No. 10/051,396, entitled VIRTUALIZATION IN A STORAGE SYSTEM, filed Jan. 18, 2002

Provisioning an Initiator Connection

When a server or other initiator is connected to a switch and the initiator supports iSNS or SLP, in one embodiment the initiator will register itself with the switch, resulting in an initiator object stored in the SCC database. In other embodiments, however, the switch will include an access provisioning function which creates, updates, or deletes an initiator connection.

In creating the access connection—the connection between the switch and an initiator (such as a server)—a user will specify various parameters such as, for example, the server WWUI, connection detail, such as protocol (e.g., GigE or Fiber Channel), exclusive or shared, source and destination IP addresses, minimum and maximum percentage of bandwidth, # of connections required by the server, access security, read only or read/write, and VPN enabled, etc.

Some or all of the user specified information is saved in an initiator object stored in the SCC database. When the connection is removed, the initiator object will be deleted.

The switch, the management station, or other network management then creates a storage pool for the particular connection, specifying the LUs available to the initiator to form virtual targets.

User Domains

Like physical devices, virtual targets can be assigned to a pool accessible only to those with specified characteristics. Thus, like physical devices, virtual targets can be assigned to a user-specific domain (sometimes referred to herein as the User's Domain), a default domain (accessible to anyone), or a No Domain. Each domain will be identified, in one embodiment, by an object in the SCC database that includes a listing of all the virtual targets assigned to the domain. For virtual targets, the No Domain may include spare virtual targets, members of mirrored virtual targets, or remote virtual targets from another switch. Essentially, the virtual target No Domain is a parking place for certain types of virtual targets. For ease of description, when referring to virtual targets, pools will be referred to herein as “domains,” but when referencing physical devices, pools will continue to be referred to as “pools.” It is to be understood, however, that conceptually “pools” and “domains” are essentially the same thing.

Once an initiator connection is provisioned, as described above, a virtual target is provisioned that meets the initiator's requirements and placed into an accessible pool for the initiator or a previously provisioned virtual target is made accessible to the initiator, e.g., by moving the virtual target to the initiator's user domain from another domain such as the No Domain or Default Domain. (Note that either the virtual target or the initiator connection can be provisioned first—there is no requirement that they be provisioned in a particular order). Then, once an initiator requests access to the virtual target, e.g., by sending a read or write request, both the virtual target object and initiator object are read from the SCC database and information regarding the initiator connection and virtual target is passed to the relevant linecard(s) for use in processing the requests.

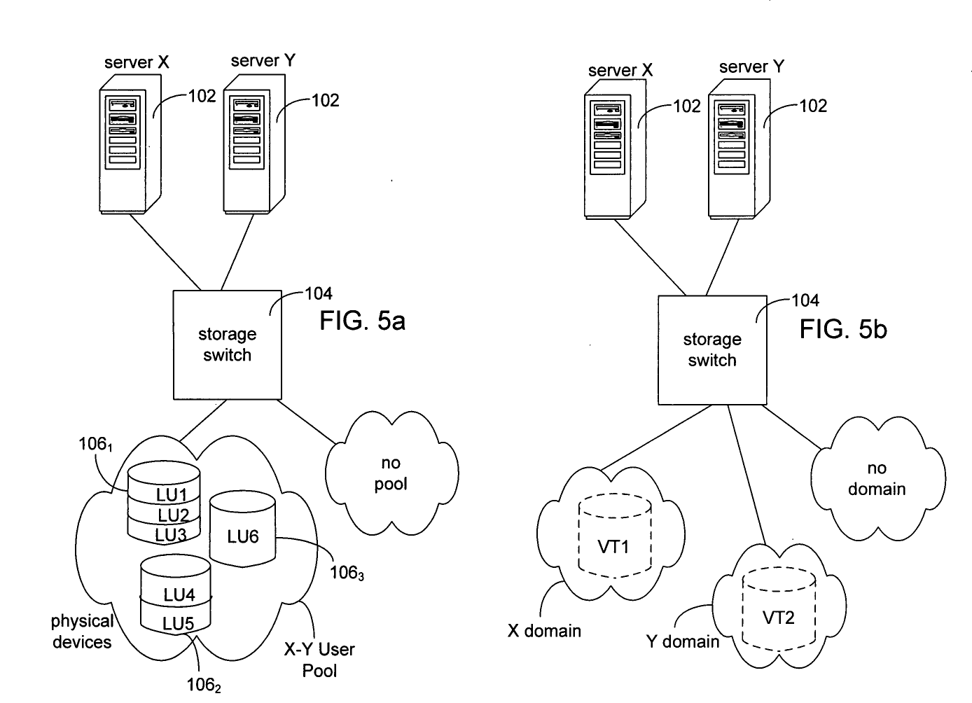

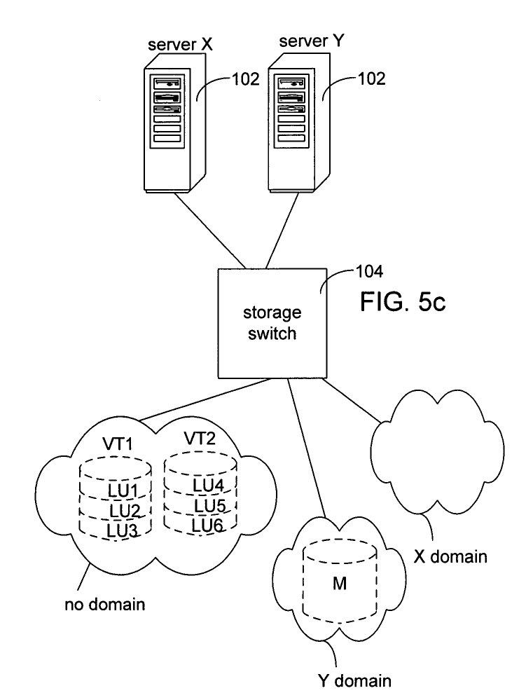

FIGS. 5a-5c illustrate one example of provisioning virtual targets in a storage area network. The system of FIGS. 5a-5c includes three physical devices 106₁, 106₂, and 106₃, having a total of 6 LUs—LU1, LU2, LU3, LU4, LU5, LU6. In FIG. 5a, each physical device is coupled to a switch and placed in a pool accessible to two initiators X and Y, the “X-Y User Pool.”

If initiator X and initiator Y each require one virtual target, then in one embodiment, the LUs are provisioned to form virtual targets VT1 and VT2, where VT1 includes as extents LUs 1-3 and VT2 includes as extents LUs 4-6 as depicted in FIG. 2b. VT1 is placed in the server X user domain and VT2 is placed in the server Y user domain. Initiator X will have access to VT1 but no VT2, while initiator Y will have access to VT2 but not VT1.

If instead, for example, initiator Y requires a mirrored virtual target M with a total of 6 LUs, VT1 and VT2 can be created as members of the virtual target M. VT1 and VT2 can be placed in the switch's No Domain (a domain where the physical targets are not directly accessible to users) while M is made accessible to Y, as shown in FIG. 2c. As members of M, VT1 and VT2 will not be independently accessible. VT1 is comprised of a LUs 1-3 (physical device 106₁), while VT2 is comprised of LUs 4-6 (physical devices 106₂ and 106₃). When a request is received to write data to the virtual target M, switch 104 will route the incoming data to both VT1 (physical device 106₁) and VT2 (physical device 106₂ and/or 106₃), thus storing the data in at least two physical locations.

Objects

As discussed above, each virtual target, each initiator connection, and each physical device is identified in the SCC database with information included in an object for the respective entity. Each virtual target object and physical target object will include a listing of extents or LUs that comprise it. An example of a Virtual Target object, in one embodiment of the invention, includes the following information:
entity type
entity identifier
managing IP address
time stamp and flags
ports
domain information
SCN bit map
capacity and inquiry information
number of extents
list of extents
extent locator
virtual mode pages
quality of service policy (e.g., the first three entries of Table 4)
statistics—usage, error, and performance data
SLA identifier
   A physical target (or LU) object may include similar information. More information regarding VTD information can be found in U.S. patent application Ser. No. 10/051,396, entitled VIRTUALIZATION IN A STORAGE SYSTEM, filed Jan. 18, 2002.

Classification for Storage Switch

As packets or frames (generically referred to herein as “packets”) arrive at the storage switch they are separated at each port into data and control traffic. Data traffic is routed to the PPU for wire-speed virtualization and translation, while control traffic such as connection requests or storage management requests are routed to the CPU. This separation is referred to herein as “packet classification” or just “classification” and is generally initiated in the PACE of the SPU. Accordingly, unlike the existing art, which forwards all packets to the CPU for processing, a system in accordance with the invention recognizes the packet contents, so that data traffic can be processed separately and faster, aiding in enabling wire-speed processing. GigE packets and FC frames are handled slightly differently, as described below.

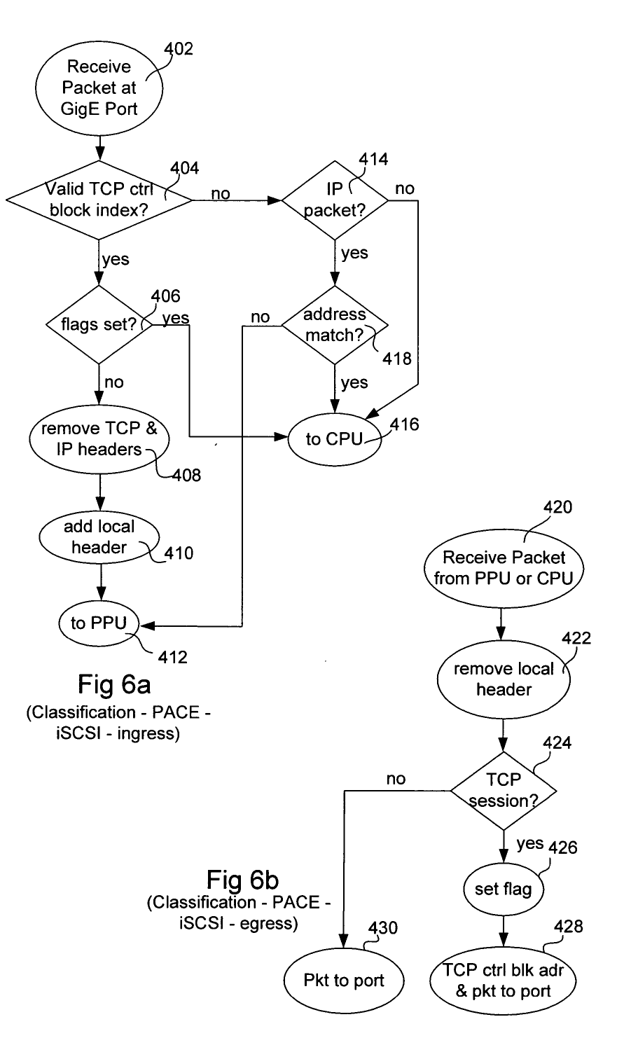

For packets arriving at a GigE port in the ingress direction (packets arriving at the switch), the following steps will be described with reference to FIG. 6a. A GigE port will receive a packet, which in one embodiment is either an IP packet or an iSCSI packet, step 402. Once the packet is received, the PACE determines if a virtual target access is recognized by whether it receives from the port a valid TCP Control Block Index with the packet (e.g., an index that is not −1), step 404. If there is a valid TCP Control Block Index, the PACE next checks the flags of the packet's TCP header, step 406. If the SYN, FIN, and RST flags of the TCP header are set, the packet is forwarded to the CPU, step 416, as the CPU would be responsible to establish and terminate a TCP session. Once an iSCSI TCP session is established, for managing the TCP session, the GigE port will receive a valid TCP control block from the CPU. But if the flags are not set, then in one embodiment the PACE will remove the TCP, IP, and MAC headers, step 408, leaving the iSCSI header, and then add a local header, step 410. Other embodiments, however, may leave the TCP, IP and MAC headers, and simply add a local header. Once the local header is added, the packet is sent to the PPU, step 412.

A local header can include a VTD ID to identify a VTD for a particular connection, a Flow ID to specify the destination port for a packet, a TCP Control Block Index to specify a TCP control block for a particular connection (if a TCP connection), a Type field to specify the packet classification (e.g., data or control), a Size field to indicate packet size, Task Index to track and direct the packet within the switch as well as to locate stored information related to the packet for the particular task, as well as some hardware identifiers such as source identifiers (e.g., identifying a source port, PACE, linecard, and/or CPU) and destination identifiers (e.g., identifying a distinction Port, PACE linecard, and/or CPU). The local header is used by various devices (e.g., PACE, PPU) throughout the switch. Accordingly, in some instances not all fields of the local header will be fully populated and in some instances the field contents may be changed or updated. An example of a local packet and conversion of a TCP packet can be found in co-pending U.S. patent application Ser. No. 10/051,321.

In the event that there is no valid TCP Control Block Index, step 604, then it is determined if the packet is an IP packet, step 414. If the packet is not an IP packet, it is forwarded to the CPU, step 416. If the packet is an IP packet, then the PACE checks the destination IP address, step 418. If the IP address matches that of the port of the storage switch, the packet is sent to the CPU, step 416, for processing. If the IP address does not match that of the port of the storage switch, then it is routing traffic and is forwarded to the PPU, step 412.

Referring to FIG. 6b, when a packet destined for a GigE port is received in the egress direction by the PACE from an PPU or CPU, step 420, the PACE removes the local header, step 422. If the packet is for a TCP session, step 424, the PACE sets a control flag in its interface with the port to so inform the GigE port, step 426. If the packet is for a TCP session, the PACE passes the packet and the TCP Control Block Index to the port using interface control signals, step 428. If there is no TCP session, the packet is simply passed to the port, step 4300.

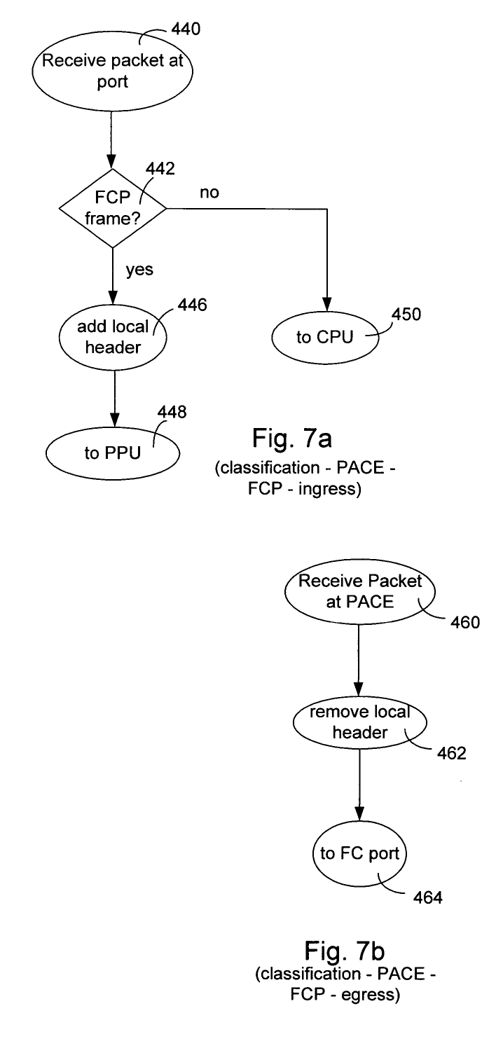

FIG. 7a illustrates the steps that occur at the PACE in classifying packets that arrive from an FC port. Unlike for a GigE port, the PACE for an FC port does not have to deal with a TCP Control Block Index. Instead, upon receiving a packet at an FC port, step 440, the S_ID field of the FCP frame header can be consulted to determine if the frame belongs to an open FC connection, however, this step is performed after the packet is passed to the PPU. Thus, the PACE only need determine if the frame is an FCP frame, step 442, which can be determined by consulting the R_CTL and TYPE fields of the frame header. A local header 4 is added, step 444, although the FCP frame header is not removed at this point as the data in the header will be useful to the PPU later. The local packet is then passed to the PPU, step 448. If the frame is not an FCP frame, it is passed to the CPU, step 450.

Referring to FIG. 7b, when a packet destined for an FC port is received in the egress direction by the PACE from an PPU or CPU, step 460, the PACE simply removes the local header, step 462, before passing the frame to the FC port, step 464. The local header will indicate to the PACE which port (of the two ports the PACE is connected to) the packet is destined for.

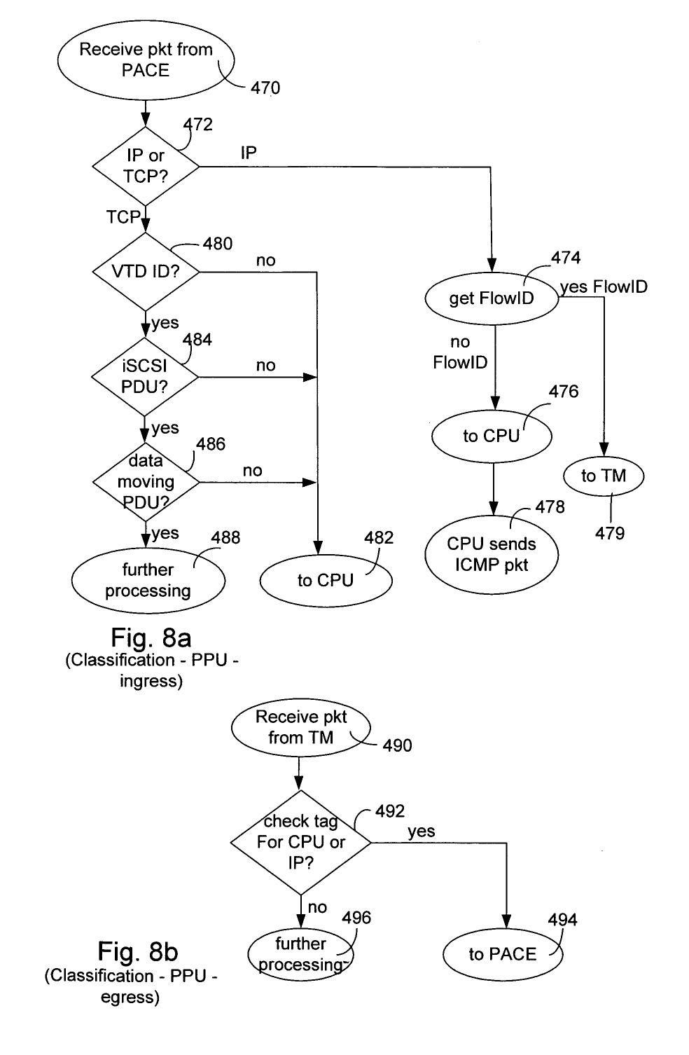

For packets received at either a GigE or FC port and that are passed to the PPU, the PPU further separates control traffic in one embodiment. Referring to FIG. 8a, when the PPU receives a packet from the PACE, step 470, the PPU determines if it is an IP or TCP packet, step 472. If the packet is an IP packet, the PPU searches its CAM to obtain the Flow ID of the packet from its route table, step 474. If the search fails, the packet has an unknown destination IP address, and it is passed to the CPU, step 476, which in turn sends an ICMP packet back to the source IP address step 478. If the search returns a Flow ID, then the packet is forwarded to the Traffic Manager, step 479.

When the packet received is a TCP packet, step 472, the PPU searches its CAM using the TCP Control Block Index, which identifies the TCP session, together with the LUN from the iSCSI header, which identifies the virtual target, to get a virtual target descriptor ID (VTD ID), step 480. The VTD ID's are essentially addresses or pointers to the VTDs stored in the PPU SRAM. The PPU uses the VTD ID to obtain the address of the VTD, step 480, so a search of VTD ID's allows the ability to quickly locate a VTD. If the VTD cannot be obtained, then the iSCSI session has not yet been established, and the packet is sent to the CPU, step 482. But if the VTD ID is obtained in step 480, the PPU determines if the packet contains an iSCSI PDU, step 484. If the packet does not contain an iSCSI PDU, it is forwarded to the CPU, step 482. But if it does include an iSCSI PDU, the PPU determines if the PDU is a data moving PDU (e.g., read or write command, R2T, write data, read data, response), step 486. If the PDU is not a data moving PDU, then the packet is passed to the CPU, step 482. But if the PDU is a data moving PDU, then the PPU performs further processing on the packet, step 488, e.g., virtualization and translation, as will be described later.

When the PPU receives an FCP frame with an FCP command IU in the ingress direction, the PPU performs similar steps to those described in FIG. 8a, steps 470, 480-488, except that the CAM search in step 480 uses the S_ID address and the LUN from the FCP frame to find the VTD ID.

In the egress direction, shown in FIG. 8b, after receiving a packet from the traffic manager, step 490, the PPU checks the Type field of the local header, step 492. If the field indicates that the packet is an IP packet or a packet destined for the CPU, then the PPU sends the packet to the PACE, step 494. Otherwise, the PPU performs further processing on the packet, step 496, e.g., virtualization and translation, as will be described later.

As described above, the CPU will be passed packets from the SPU in several situations. These situations include:
1. A non-TCP packet having the storage switch as its destination. Such a packet could be an ICMP, IP, RIP, BGP, or ARP packet, as are understood in the art. The CPU performs the inter-switch communication and IP routing function. The packet may also be SLP or iSNS requests that will be forwarded to the SCC.
2. An IP packet without a CAM match to a proper routing destination. While this situation will not frequently occur, if it does, the CPU returns an ICMP packet to the source IP address.
3. A non-iSCSI TCP packet. Such a packet would generally be for the CPU to establish or terminate a TCP session for iSCSI and will typically be packets with SYN, FIN, or RST flags set.
4. A non-FCP FC frame. Such frames are FLOGI, PLOGI, and other FCP requests for name services. Similar to iSCSI TCP session, these frames allow the CPU to recognize and to communicate with the FC devices. In one embodiment, the CPU needs to communicate with the SCC to complete the services.
5. An iSCSI PDU that is not a SCSI command, response, or data. Such a packet may be a ping, login, logout, or task management. Additional iSCSI communication is generally required before a full session is established. The CPU will need information from the SCC database to complete the login.
6. An iSCSI command PDU with a SCSI command that is not Read/Write/Verify. These commands are iSCSI control commands to be processed by the CPU where the virtual target behavior is implemented.
7. An FCP frame with a SCSI command that is not Read/Write/Verify. These commands are FCP control commands to be processed by the CPU where the virtual target behavior is implemented.
   Switch-Based Storage Operations

One of ordinary skill in the art will have a general knowledge of the iSCSI and FC protocols. However, for more information on iSCSI refer to “draft-ietf-ips-iSCSI-20.txt,” an Internet Draft (see www.ietf.org) and work in progress by the Internet Engineering Task Force (IETF), Jan. 19, 2003, incorporated herein by reference in its entirety. For more information about Fibre Channel (FC) refer to “SCSI Fibre Channel Protocol—2 (FCP-2)”, Nov. 23, 2002, Rev: 08 (see www.t10.org), incorporated herein by reference in its entirety. In addition, both are further described in U.S. patent application Ser. No. 10/051,321, entitled STORAGE SWITCH FOR STORAGE AREA NETWORK, filed Jan. 18, 2002.

Virtualization

Exemplary ingress and egress processes for various packet types are described for explanatory purposes only. It will be understood that numerous processes for various packet types can be used in accordance with various embodiments. In one embodiment, after an incoming packet is classified as data or control traffic by the PPU, the PPU can perform virtualization for data packets without data buffering. For each packet received, the PPU determines the type of packet (e.g., command, R2T/XFER_RDY, Write Data, Read Data, Response, Task Management/Abort) and then performs either an ingress (where the packet enters the switch) or an egress (where the packet leaves the switch) algorithm to translate the virtual target to a physical target or vice versa. Thus, the virtualization function is distributed amongst ingress and egress ports. To further enable wire-speed processing, virtual descriptors are used in conjunction with a CAM, to map the request location to the access location. In addition, for each packet there may be special considerations. For instance, the virtual target to which the packet is destined may be spaced over several noncontiguous extents, may be mirrored, or both.

Command Packet—Ingress

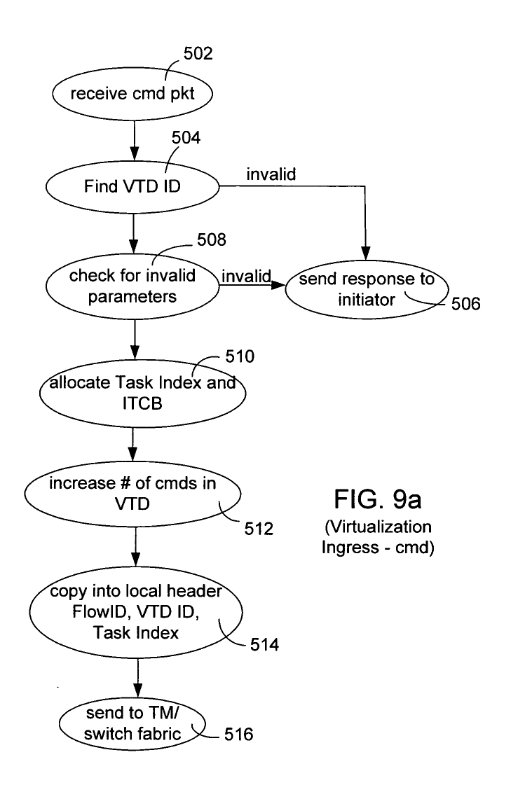

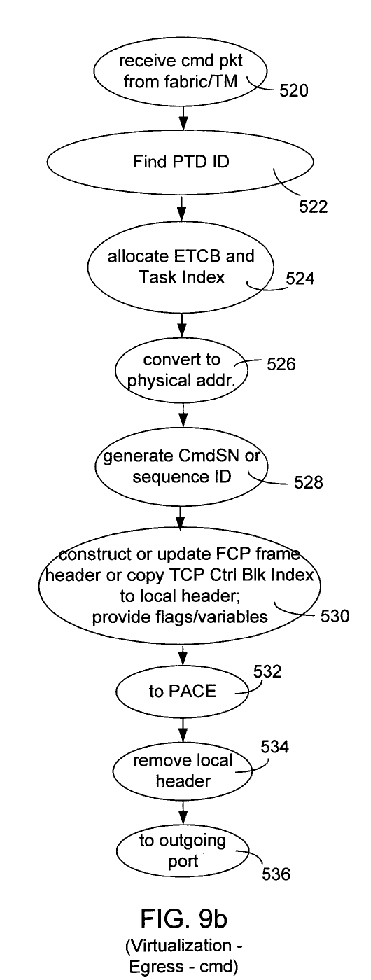

To initiate a transfer task to or from the virtual target, a SCSI command is sent by an iSCSI or FC initiator in an iSCSI PDU or FCP IU, respectively. Referring to FIG. 9a, when such a packet is received at the PPU (after classification), step 502, the PPU CAM is next checked to determine if a valid VTD ID exists, using the TCP Control Block Index and the logical unit number (LUN), in the case of an iSCSI initiator, or the S_ID (an identification of the source of the frame) and the LUN, in the case of an FC initiator, step 504. The LUNs in each case are found in the respective iSCSI PDU or FCP IU. If no valid VTD ID is found, then a response packet is sent back to the initiator, step 506. If a valid VTD is found, then a check is made for invalid parameters, step 508. If invalid parameters exists, a response packet is sent back to the iSCSI or FC initiator, step 506.

A Task Index is allocated along with an Ingress Task Control Block (ITCB), step 510. The Task Index points to or identifies the ITCB. The ITCB stores the Flow ID (obtained from the VTD), the VTD ID, command sequence number or CmdSN (from the iSCSI packet itself), as well as an initiator (originator) identification (e.g., the initiator_task_tag sent in the iSCSI PDU or the OX_ID in the FCP frame header). The OX_ID is the originator (initiator) identification of the exchange. The ITCB is stored in the PPU SRAM. Of course there may be many commands in progress at any given time, so the PPU may store a number of ITCBs at any particular time. Each ITCB will be referenced by its respective Task Index.

The VTD tracks the number of outstanding commands to a particular virtual target, so when a new ITCB is established, it increments the number of outstanding commands, step 512. In some embodiments, VTDs establish a maximum number of commands that may be outstanding to any one particular virtual target. The Flow ID, the VTD ID, and the Task Index are all copied into the local header, step 514. The Flow ID tells the traffic manager the destination linecards and ports. Later, the Task Index will be returned by the egress port to identify a particular task of a packet. Finally, the packet is sent to the traffic manager and then the routing fabric, so that it ultimately reaches an egress PPU, step 516.

When a virtual target is composed of multiple extents, there are multiple Flow IDs identified in the VTD, one for each extent. The PPU checks the block address for the packet and selects the correct Flow ID. For example, if a virtual target has two 1 Gb extents, and the block address for the command is in the second extent, then the PPU selects the Flow ID for the second extent. In other words, the Flow ID determines the destination/egress port. If a read command crosses an extent boundary, meaning that the command specifies a starting block address in a first extent and an ending block address in a second extent, then after reading the appropriate data from the first extent, the PPU repeats the command to the second extent to read the remaining blocks. For a write command that crosses an extent boundary, the PPU duplicates the command to both extents and manages the order of the write data. When a read command crosses an extent boundary, there will be two read commands to two extents. The second read command is sent only after completing the first to ensure the data are returned sequentially to the initiator.

Command Packet—Egress

Referring to FIG. 9b, after a command PDU or IU has passed through the switch fabric, it will arrive at an PPU, destined for an egress port, step 520. The PPU attempts to identify the physical device(s) that the packet is destined for, step 522. To do so, the VTD ID from the local header is used to search the PPU CAM for a PTD ID (Physical Target Descriptor Identifier). The VTD ID is affiliated with and indexes a particular PTD ID associated with the particular egress PPU. PTDs are stored in the PPU SRAM, like VTDs, and also contain information similar to that found in a VTD. If the search is unsuccessful, it is assumed that this is a command packet sent directly by the CPU and no additional processing is required by the PPU, causing the PPU to pass the packet to the proper egress port based on the Flow ID in the local header. If the search is successful, the PTD ID will identify the physical target (including extent) to which the virtual target is mapped and which is in communication with the particular egress linecard currently processing the packet.

The PPU next allocates a Task Index together with an egress task control block (ETCB), step 524. In an embodiment, the Task Index used for egress is the same as that used for ingress. The Task Index also identifies the ETCB. In addition, the ETCB also stores any other control information necessary for the command, including CmdSN of an iSCSI PDU or an exchange sequence for an FCP IU.

Using the contents of the PTD, the PPU converts the SCSI block address from a virtual target to the block address of a physical device, step 526. Adding the block address of the virtual target to the beginning block offset of the extent can provide this conversion. For instance, if the virtual target block sought to be accessed is 1990 and the starting offset of the corresponding first extent is 3000, then the block address of the extent to be accessed is 4990. Next the PPU generates proper iSCSI CmdSN or FCP sequence ID, step 528 and places them in the iSCSI PDU or FCP frame header. The PPU also constructs the FCP frame header if necessary (in some embodiments, after the ingress PPU reads the necessary information from the FCP header, it will remove it, although other embodiments will leave it intact and merely update or change the necessary fields at this step) or for a packet being sent to an iSCSI target, the TCP Control Block Index is copied into the local header from the PTD, step 530. In addition, the PPU provides any flags or other variables needed for the iSCSI or FCP headers. The completed iSCSI PDU or FCP frame are then sent to the PACE, step 532, which in turn strips the local header, step 534, and passes the packet to appropriate port, step 536.

R2T or XFER_RDY—Ingress

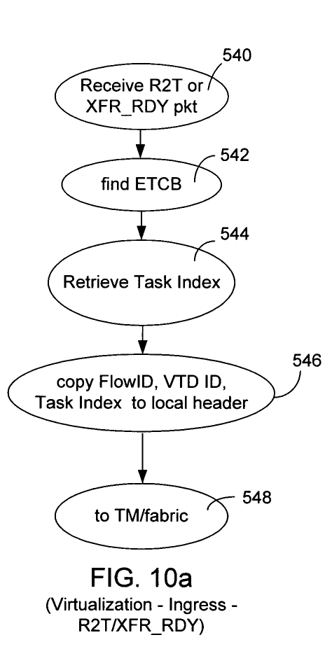

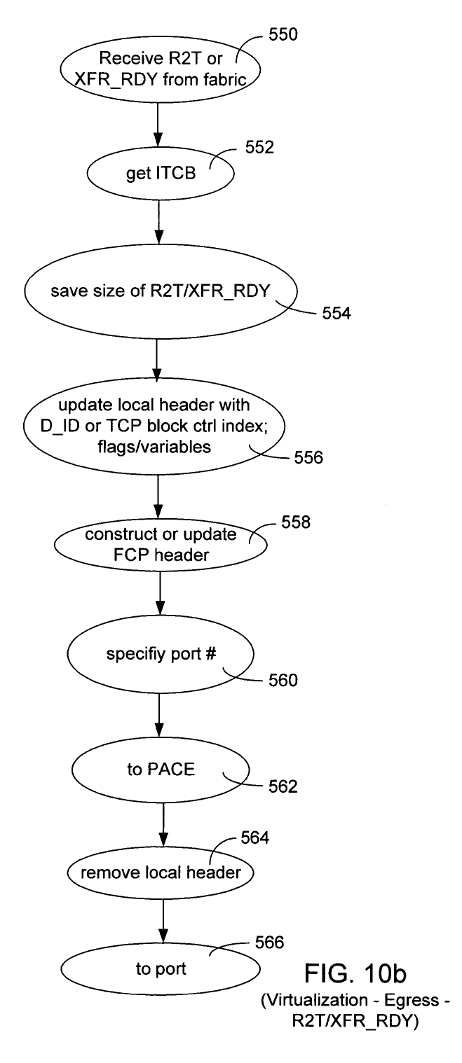

Referring to FIG. 10a, after a command has been sent to a target storage device as described above, and the command is a write command, an R2T PDU or an XFER_RDY IU will be received from a storage device when it is ready to accept write data, step 540. The PPU identifies the corresponding ETCB, step 542, by using the initiator_task_tag or OX_ID inside the packet. In some embodiments, the initiator_task_tag or OX_ID of the packet is the same as the Task Index, which identifies the ETCB. If the PPU cannot identify a valid ETCB because of an invalid initiator_task_tag or OX_ID, the packet is discarded. Otherwise, once the ETCB is identified, the PPU retrieves the Ingress Task Index (if different from the Egress Task Index) and the VTD ID from the ETCB, step 544. The PPU also retrieves the Flow ID from the PTD, which is also identified in the ETCB by the PTD ID. The Flow ID indicates to the traffic manager the linecard of the original initiator (ingress) port. The Flow ID, the VTD ID, and the Task Index are copied into the local header of the packet, step 546. Finally the packet is sent to the traffic manager and the switch fabric, step 548.

R2T or XFER_RDY—Egress

Referring to FIG. 10b, after the R2T or XFER_RDY packet emerges from the switch fabric, it is received by a PPU, step 550, on its way to be passed back to the initiator (the device that initiated the original command for the particular task). The Task Index identifies the ITCB to the PPU, step 552, from which ITCB the original initiator_task_tag and the VTD ID can be obtained. The R2T/XFER_RDY Desired Data Transfer Length or BURST_LEN field is stored in the ITCB, step 554. The local header is updated with the FCP D_ID or the TCP Control Block Index for the TCP connection, step 556. Note that the stored S_ID from the original packet, which is stored in the ITCB, becomes the D_ID. If necessary, an FCP frame header is constructed or its fields are updated, step 558. The destination port number is specified in the local header in place of the Flow ID, step 560, and placed along with the initiator_task_tag in the SCSI PDU or, for an FC connection, the RX_ID and OX_ID are placed in the FCP frame. The RX_ID field is the responder (target) identification of the exchange. The PPU also places any other flags or variables that need to be placed in the PDU or FCP headers. The packet is forwarded to the PACE, step 562, which identifies the outgoing port from the local header. The local header is then stripped, step 564 and forwarded to the proper port for transmission, step 566.

In the event that the command is split over two or more extents, e.g., the command starts in one extent and ends in another, then the PPU must hold the R2T or XFER_RDY of the second extent until the data transfer is complete to the first extent, thus ensuring a sequential data transfer from the initiator. In addition, the data offset of the R2T or XFER_RDY of the second extent will need to be modified by adding the amount of data transferred to the first extent.

Write Data Packet—Ingress

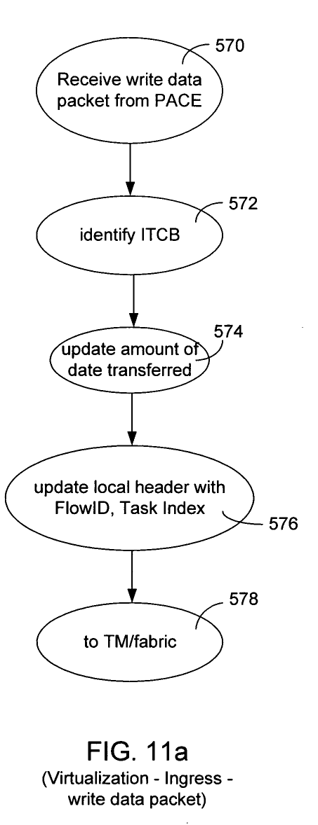

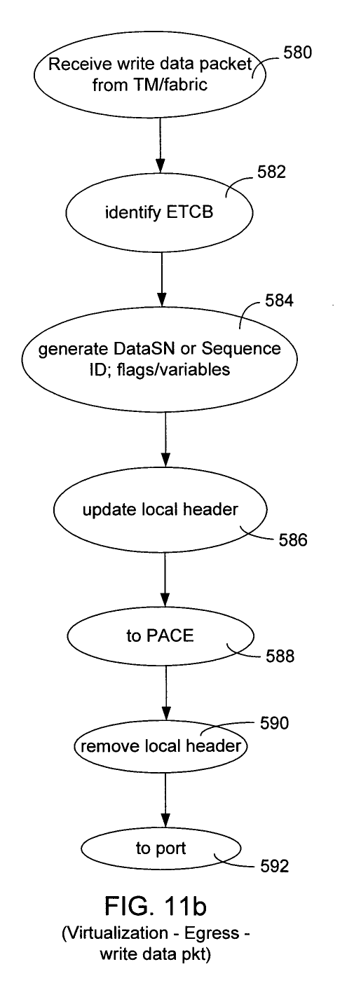

After an initiator receives an R2T or XFER_RDY packet it returns a write-data packet. Referring to FIG. 11a, when a write-data iSCSI PDU or FC IU is received from an initiator, step 570, the ITCB to which the packet belongs must be identified, step 572. Usually, the ITCB can be identified using the RX_ID or the target_task_tag, which is the same as the Task Index in some embodiments. The SPU further identifies that received packets are in order. In some circumstances, however, the initiator will transfer unsolicited data: data that is sent prior to receiving an R2T or XFER_RDY. In such a case, the PPU must find the ITCB by a search through the outstanding tasks of a particular virtual target. But if the ITCB is not found, then the packet is discarded. If the ITCB is found, the total amount of data to be transferred is updated in the ITCB, step 574. The Flow ID and Task Index are added to the local header of the packet, step 576. The packet is then forwarded to the traffic manager and ultimately to the switch fabric, step 578.

Write Data Packet—Egress

Referring to FIG. 11b, when a write-data packet is received from the switch fabric (via the traffic manager), step 580, the ETCB for the packet needs to be identified, step 582. Typically, the ETCB can be identified using the Task Index in the local header. Once the ETCB is found, using the information inside the ETCB, the PPU generates proper iSCSI DataSN or FCP sequence ID, step 584, along with any other flags and variables, e.g, data offset, for the PDU or FCP frame header. The local header is updated with the TCP Control Block Index or the FCP D_ID from the PTD, step 586. The port number is also added to the local header. The finished iSCSI PDU or FCP frame is sent to the PACE, step 588, which removes the local header, step 590, and forwards the packet to the appropriate port, 592.

Mulit-Chassis Multi-Path Storage Solutions

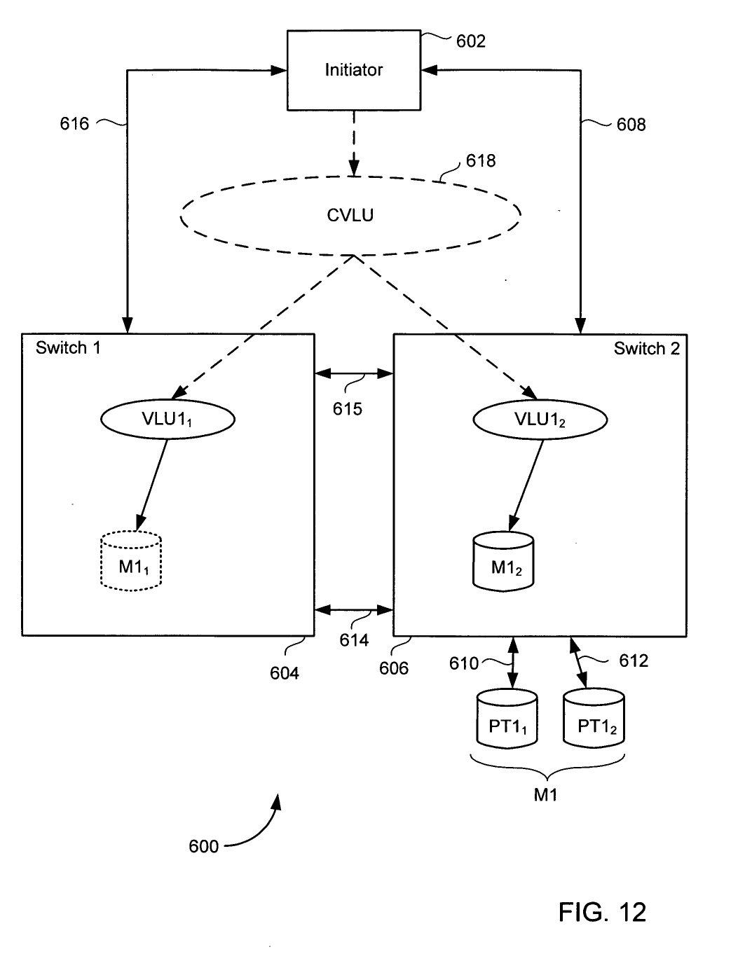

FIG. 12 depicts a block diagram of a storage area network 600 in accordance with one embodiment for providing high availability of storage subsystems and data. Network 600 includes an initiator 602, a first storage switch 604, a second storage switch 606 and physical targets PT1₁ and PT1₂. Physical targets PT1₁ and PT1₂ are connected to switch 606 via one or more ports at one or more line cards of switch 1206. A virtual logic unit VLU1₂ has been provisioned at switch 606 to include a member M1 representing or mapping to physical targets PT1₁ and PT1₂.

Provisioned virtual target VLU1₂ represents two levels of virtualization within storage switch 606. The virtualization of one or more storage subsystems into members at switch represents a first level of virtualization. At switch 606, the combination of physical targets PT1₁ and PT1₂ is virtualized to create member M1, representing a first level of virtualization at switch 606. The virtualization of one or more members to create a virtual target or virtual logical unit represents a second level of virtualization. At switch 606, M1 is provisioned as a member of VLU1₂, representing a second level of virtualization.

Initiator 602 is connected to switch 606 via one or more ports at one or more line cards of the switch. VLU1₂ can be made accessible to initiator 602 by placing the unit into an accessible domain for the initiator. Initiator 602 can access VLU1₂ by passing read and write requests to the switch. Switch 606 will read the virtual target object provisioned for VLU1₂ and the initiator object provisioned for initiator 602 and pass initiator and virtual target information to the relevant line cards to process the request. Accordingly, initiator 602 can access data stored on, and write data to, physical targets PT1₁, and PT1₂ without knowledge of the underlying storage subsystems by issuing appropriate commands and data for VLU1₂.

In typical storage switches and storage area networks, a physical target is only accessible via the storage switch to which it is physically connected. Thus, if the storage switch or the connection between an initiating device and the storage switch becomes unavailable, then the physical target and the data residing thereon will become unavailable. For example, if data path or connection 608 between initiator 602 and switch 606 is lost, initiator 602 will be unable to provide requests for VLU1₂. Similarly, if either of data paths 610 or 612 between switch 606 and physical targets PT1₁ and PT1₂ are lost, switch 606 will be unable to fulfill requests involving the physical target of the lost path. Obviously such unavailability of data and devices can present problems in any storage area network and in particular, those networks where fast, accurate, and reliable access of data is necessary.

In accordance with one embodiment, multiple paths over multiple chassis's to physical targets are provided across one or more storage switches in order to provide alternate or additional access to such physical devices. An inter-chassis link (ICL) 614 is provided between storage switches 604 and 606 for communication between each chassis. Inter chassis link 614 can be formed between ports at a line card of each storage switch. Inter chassis link 614 can include any suitable protocol such as fiber channel, Gigabit Ethernet (utilizing iSCSI protocol), or Internet Protocol (IP). In one embodiment, an IP link 615 is provided in addition to ICL 614. Additionally, multiple ICLs 614 can be provided as more fully described hereinafter. The switches can be connected directly, over one or more networks, or have other switches connected with similar ICLs, as more fully described hereinafter.

With such available communication between switches established, physical targets connected at one switch can be virtualized at a second switch. For example physical targets PT1₁ and PT1₂ can be virtualized as one or more members at switch 604. As depicted in FIG. 12, physical targets PT1₁ and PT1₂ are virtualized as member M1₁. VLU1₁ will include much of the same information as VLU1₂ at switch 606, however, VLU1₁ will include information to designate that the physical targets PT1₁ and PT1₂ are remotely located at switch 606. VLU1₁ can include destination information (e.g., a Flow ID in the associated VTD) specifying the line card at which the ICL is provided rather than information specifying the port and line card to which the physical target is located, as with targets virtualized at the switch to which they are located. When command and data packets are received for VLU1₁, a local header can be added to the packet that specifies the port and line card of the ICL. In one embodiment, a special ICL frame header is added to packets to transport messages between chassis in addition to a local header (as previously described) that can be added to specify port and line card information at which the physical targets are connected.

Member M1₁ and M1₂ are essentially the same member, both referencing the same physical storage. Their difference lies in the destination information for accessing that physical storage. A VTD and Flow ID (or portion of a VLU VTD associated with the member) for member M1₂ will reference a linecard and port to which targets PT1₁ and PT1₂ are connected. A VTD and Flow ID for M1₁, however, will reference a linecard a port of ICL connection 614 and/or 615. Members like M1₁ may be referred to as remote members to indicate such remote provisioning and to distinguish the virtualization of the physical storage at the two (or more) switches.

Provisioning virtual target VLU1₂ and member M1₂ is not a requirement for provisioning VLU1₁ and M1₁ for remotely located physical targets PT1₁ and PT1₂. VLU1₁ can operate independently at switch 604 to provide access to targets PT1₁ and PT1₂ across ICL 614. A VTD provisioned for VLU1₁ can maintain the necessary information (Flow ID, etc.) for virtualizing incoming messages and determining relevant physical information. Such configuration of VLU1₁ independent of VLU1₂ can provide for multi-chassis pathing to physical targets PT1₁ and PT1₂.

However, in accordance with other embodiments, VLU1₁ and VLU1₂ can be provisioned to provide a multi-path storage solution taking advantage of a multi-chassis configuration. Accordingly, high availability of data of physical targets provisioned in such a manner can be achieved.

Referring again to FIG. 12, VLU1₁ is provisioned at switch 604 to include member M1₁ (remote), corresponding to physical targets PT1₁ and PT1₂ while VLU1₂ is provisioned at switch 606 to include member M1₂, corresponding to the same physical targets. In accordance with one embodiment, VLU1₁ and VLU1₂ are assigned the same virtual target or virtual logical unit identification (e.g., VLU ID) to provide an apparent single virtual logical unit to initiating devices. This apparent single volume, formed of two individual VLUs at separate storage switches having the same identification, is referred to herein as a clustered virtual logical unit (CVLU). As previously described, virtual targets can be identified by a VLU ID. VLU1₁ and VLU1₂ are assigned the same VLU ID so that a single volume can be presented to host devices connected to both switches 604 and 606.

Initiator 602, connected to switch 606 via line 608, will see a volume at switch 606 having the assigned VLU ID to VLU1₂. Initiator 602, via line 616, will see the apparent same volume at switch 604 by virtue of VLU1₁ having the same VLU ID as VLU1₂. Thus, initiator 602 will see two paths to the same logical unit or volume. That is to say, although distinct VLU's have been provisioned at switches 604 and 606, they will appear as a single virtual target to initiator 602 by virtue of having same assigned VLU ID.

The volume appearing to initiating devices is denoted as CVLU 618. CVLU 618 is not an actual provisioned logical unit within either of switches 604 or 606. CVLU 618, depicted in FIG. 12, represents the conceptualized clustering of VLU1₁ and VLU1₂ by virtue of assigning the same VLU ID. Thus, initiator 602 will see the same virtual target along paths 608 and 616. The clustering of VLUs across storage switches provides a third level of virtualization within the switches for multi-path availability of physical targets.

The availability and access of VLU1₁ and VLU1₂ can both be active at any given time. VLU1₁ and VLU1₂ can both accept requests for the target and provide two active paths to physical targets PT1₁ and PT1₂. There is no requirement that only one available connection or VLU be active at one time. Such a configuration is referred to as an active/active connection for the virtual target.

The resulting functionality of such a provisioning allows multiple paths across multiple switches from initiating devices to the same physical target(s). For example, if path 608 becomes unavailable between initiator 602 and switch 606, physical targets PT1₁ and PT1₂, and the data residing thereon, can be accessed via path 616 without any loss of service or interruption to initiator 602. As is common and well known in the art, host devices can include multiple connections to a destination volume or target. For example, a server can provide two direct paths to the same physical storage subsystem. Such multiple paths are managed in initiating devices by well known software such as STORAGE FOUNDATION™ with DYNAMIC MULTIPATHING OPTION, available from VERITAS Software Corporation of 350 Ellis Street, Mountain View, Calif. 94043. Such software can utilize either of the available paths to access the destination. Accordingly, to initiating devices coupled to multiple storage switches having VLUs with the same LUN in accordance with embodiments, the target VLUs will simply appear as a single target with multiple paths provided thereto. Such software can be intelligent and choose optimal paths or be set in any configuration desired to utilize either of multiple paths as well as to allow selection of an individualized path. Accordingly, should path 616 become unavailable, initiator 602 can access switch 606 via path 608 to access the virtual target and underlying storage subsystems. A CVLU can thus provide virtualization of the same physical storage across multiple storage switches. The CVLU can provide access to the storage through multiple switches without host or initiating devices needing any specialized switch or storage subsystem related software for realizing the CVLU.

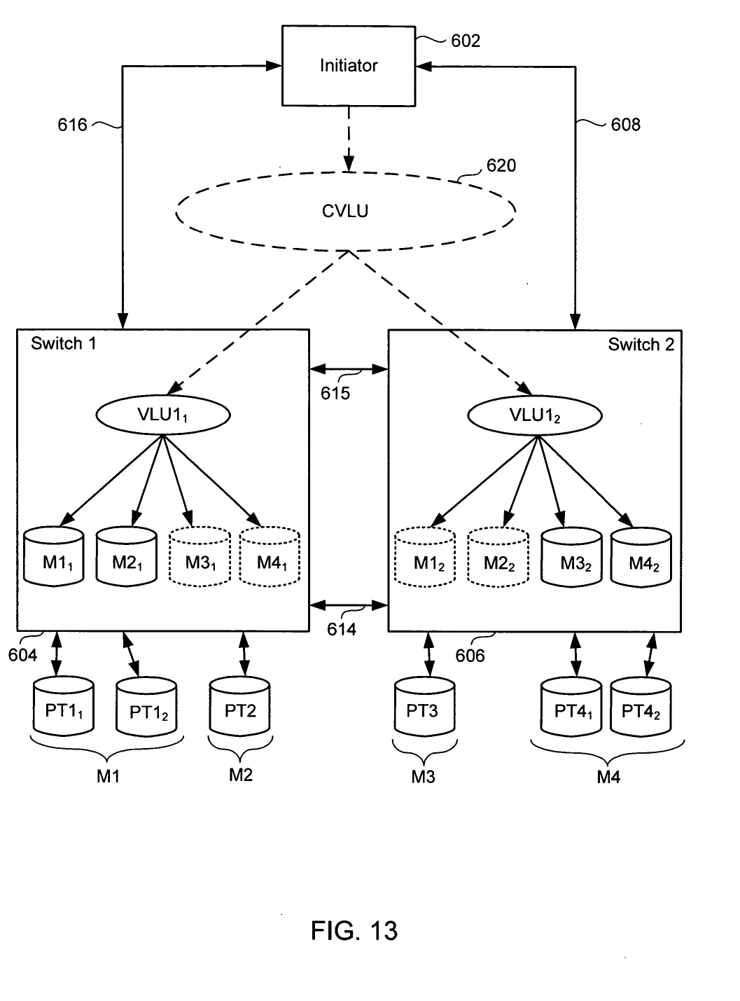

In accordance with one embodiment, the multi-chassis, multi-pathing solution depicted in FIG. 12 can be expanded to provide a mirrored virtual logical unit across switches, as depicted in FIG. 13. FIG. 13 depicts a block diagram of a storage area network including initiator 602, switch 604 and switch 606. Physical targets PT1₁, PT1₂ and PT2 are physically connected to switch 602. Physical targets PT3, PT4₁ and PT4₂ are connected to storage switch 604. Physical targets PT1₁ and PT1₂ are virtualized at switch 604 as member M1₁. Physical target PT2 is virtualized at switch 1 as member M2₁. Physical target PT3 is virtualized at switch 606 as member M3₂ and physical targets PT4₁ and PT4₂ are virtualized at switch 606 as member M4₂.

VLU1₁ at switch 604 can be provisioned to include members M1₁ and M2₁. VLU1₁ can be provisioned as a local mirrored virtual target such that data for VLU1₁ is provided to both members M1₁ and M2₁ and their underlying targets. That is, data written to VLU1₁ will be routed to members M1₁ and M2₁. This will include storing the data in the physical targets corresponding to each of the mirrored members. Data for VLU1₁ will have a first copy stored within the combination of PT1₁ and PT1₂ and second copy stored within PT2. Likewise, VLU1₂ at switch 606 is provisioned as a local mirrored virtual logical unit having mirrored members M3₂ and M4₂. Data for VLU1₂ is written to both of members M3₂ and M4₂ and their respective corresponding physical targets. Thus, data from an initiating device to be stored at VLU1₂ will have a first copy routed to physical target PT3 and a second copy routed to the combination of physical targets PT4₁ and PT4₂. Such mirroring of members of a virtual target can provide for increased reliability and availability of data within a single storage switch. For example, referring to switch 604, if physical targets PT1₁ and PT1₂ of M1₁ were to become unavailable, the data could be retrieved from physical target PT2 of member M2₁. Although VLU1₁ and VLU1₂ are locally mirrored with members corresponding to at least two physical targets connected to the switch at which they are provisioned, such is not a requirement of mirroring across storage switches as hereinafter described. For example, the local VLUs could include a single member or multiple non-mirrored members.

In accordance with one embodiment, such mirroring can be expanded across storage switches to provide availability of data stored at a physical target connected to a switch which becomes unavailable. At each of the storage switches, members (or remote members) are provisioned that correspond to the physical targets connected to the other storage switch. Member M1₂ (remote) is provisioned at switch 606. Member M1₂ represents the virtualization of physical targets PT1₁ and PT1₂ (connected to switch 604) at switch 606. Likewise, physical target PT2, connected to switch 1, is virtualized at switch 606 as remote member M2₂. Similarly, physical target PT3, connected to switch 606, is virtualized at switch 604 as remote member M3₁ and physical targets PT4₁ PT4₂, connected to switch 606, are virtualized at switch 604 as remote member M4₁. Thus, members M1₁ and M1₂ represent the virtualization of the same physical storage as M2₁ and M2₂.

Members M1₁, M2₁, M3₁ and M4₁ are provisioned as members of virtual logical unit VLU1₁ at switch 604. VLU1₂ is provisioned at switch 606 to include members M1₂, M2₂, M3₂ and M4₂. VLU1₁ is provisioned with an identifier, such as a VLU ID, that is identical to the identifier provisioned for VLU1₂. This results in a clustered virtual logical unit CVLU 620. Initiator 602, via paths 616 and 618 will seemingly have access to the same volume by virtue of each of the virtual logical units being assigned the same identifier.

VLU1₁ and VLU1₂ are each provisioned as mirrored virtual logical units to provide for redundant storage or mirroring of data across switches. VLU1₁ is provisioned as a mirrored VLU with each of members M1₁, M2₁, M3₁, and M4₁ being a mirrored member. VLU1₂ is provisioned as a mirrored VLU with each of members M1₂, M2₂, M3₂, and M4₂ being a mirrored member. Accordingly, data written to either of these virtual logical units will be routed to each of the members of the virtual logical unit. Accordingly, data provided to VLU1₁ from initiator 602 is routed to members M1₁, M2₁, M3₁ and M4₁. Data for local members M1₁ and M2₁ is routed locally to targets PT1₁ or PT1₂ and PT2. Data for remote members M3₁ and M4₁ is routed from storage switch 604, across inter-chassis link 614, to target PT3 and the combination of PT4₁ and PT4₂. Thus, data written to VLU1₁ will be routed to four physical storage locations. The data will be stored in the combination of PT1₁ and PT1₂, in PT2, in PT3 and in the combination of PT4₁ and PT4₂. Data written to VLU1₂ will be routed to each of the physical devices corresponding to the mirrored members similarly as described with respect to data written to VLU1₁.

By virtue of having the data stored at physical devices connected to both of switches 604 and 606, high availability of the data can be achieved even if one of the switches becomes unavailable. For example, if switch 606 becomes unavailable, initiator 602 can access switch 604 and VLU1₁ for access to the common CVLU 620. By mirroring the virtual logical units across storage switches, access to the data stored on the physical devices is provided even if one of the storage switches becomes unavailable. A best path algorithm can be implemented to provide the best performance in given situations. For example, each VLU can be provisioned to handle read requests by accessing a local member if available to avoid accessing the ICL unless necessary.

Because the levels of virtualization are maintained within each storage switch and a single volume is presented to host devices, no specialized software is required at hosts or targets in order to provide for and utilize a clustered virtual logical unit. Host devices need not be aware that physical storage is provided across multiple switches. The hosts will be presented with a single volume such that their interaction is just as if they were accessing a single volume provisioned at a single switch.

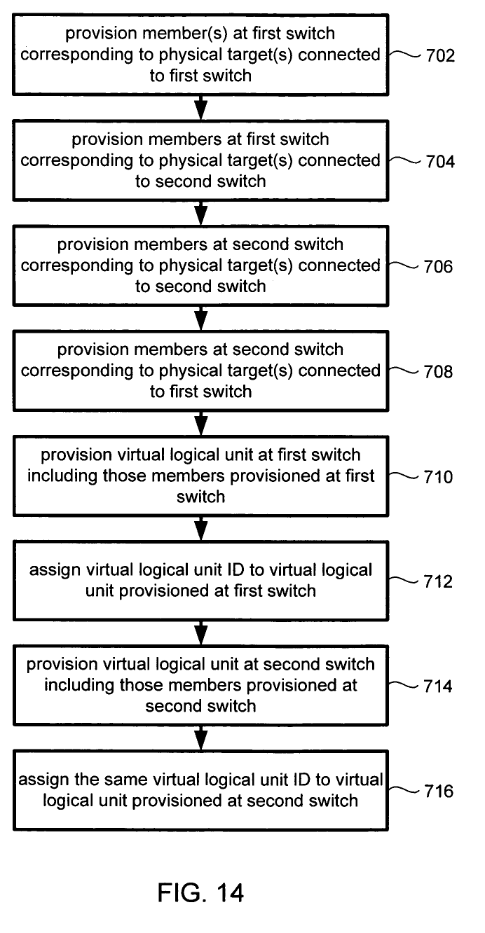

FIG. 14 is a flowchart in accordance with one embodiment depicting a method for provisioning mirrored virtual logical units across storage switches. At step 702, member(s) are provisioned at a first storage switch that correspond to physical targets connected to the first storage switch. With reference to FIG. 13, step 702 may include provisioning members M1₁ and M2₁ at switch 1 which correspond to physical targets PT1₁ and PT1₂, and PT2. At step 704, members (remote) are provisioned at the first storage switch that correspond to physical targets connected to a second storage switch. Referring again to FIG. 13, step 704 may include provisioning members M3₁ and M4₁ which correspond to physical targets PT3, and PT4₁ and PT4₂. At step 706, members are provisioned at the second storage switch that correspond to the physical targets connected to the second storage switch. In FIG. 13, step 706 may include provisioning members M3₂ (physical target PT3) and M4₂ (physical targets PT4₁ and PT4₂). At step 708, members (remote) are provisioned at the second switch that correspond to the physical targets connected to the first switch. In FIG. 13, step 708 may include provisioning members M1₂ (physical targets PT1₁ and PT1₂) and M2, (physical target PT2).

At step 710, a first virtual logical unit is provisioned at the first switch to include those members provisioned at the first switch. Step 710 may include provisioning VLU1₁ to include members M1₁, M2₁, M3₁ and M4₁. The virtual logical unit is provisioned as a mirrored unit with each of the individual members as mirrored members. As previously described, in other embodiments the VLUs are not locally mirrored. A virtual logical unit identification is assigned to the first virtual logical unit provisioned at the first switch at step 712. Step 712 can include assigning a VLU ID to the virtual logical unit. A second virtual logical unit is provisioned at the second storage switch to include those members provisioned at the second storage switch at step 714. Step 714 may include provisioning VLU1₂ to include members M1₂, M2₂, M3₂ and M4₂. At step 716, the same virtual logical unit identification assigned to the first virtual logical unit at step 712 is assigned to the second virtual logical unit provisioned at the second storage switch. For example the VLU ID assigned to VLU1₁ can be assigned to VLU1₂. Together, mirrored VLU1₁ and mirrored VLU1₂, provisioned with the same identifier, from a mirrored clustered VLU. An initiator can write data to either of VLU1₁ or VLU1₂ and have it mirrored to physical storage subsystems connected at separate storage switches.

It will be appreciated by those of ordinary skill in the art that the steps depicted in FIG. 14 do not need to be performed in the order necessarily depicted therein. For example, a first virtual logical unit could be provisioned at a first storage switch prior to provisioning any members or a second virtual logical unit at a second storage switch. Numerous alternative orders and modifications can be used in accordance with embodiments. In one embodiment, previously provisioned VLUs can be modified to include the same logical unit identifier to form a mirrored CVLU such that many of the steps of FIG. 14 can be omitted.

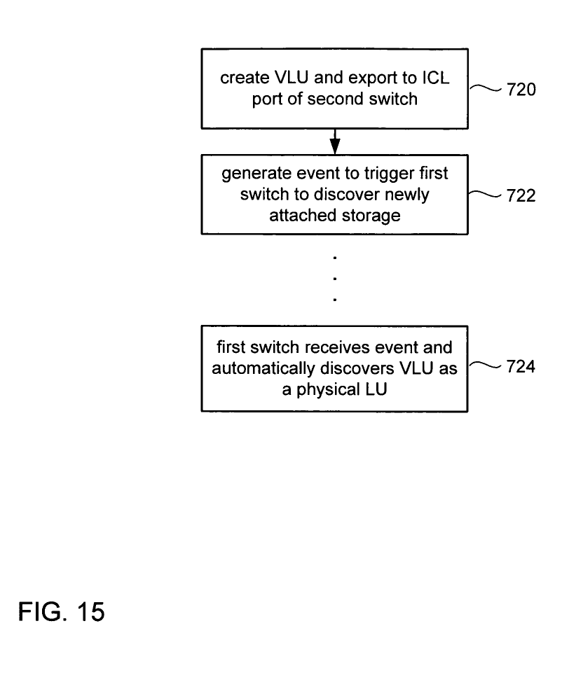

FIG. 15 is a flowchart depicting a method for provisioning a member at a first switch for physical storage connected at a second switch. FIG. 15 could be used to provision the remote members at steps 704 and 708 of FIG. 14. At step 720, a virtual logical unit is created from the physical storage and exported or provisioned to the port of the ICL connection at the second switch. The VLU represents the physical storage for which the member is being created and step 720 can include exporting the VLU to memory accessible at the ICL port. An event message is generated and passed across the ICL connection to the first switch at step 722. The event message (e.g., an RSCN message in the fibre channel protocol) can alert the first switch that new physical storage is connected to the first switch at its ICL connection. The VLU provisioned at the ICL of the second switch will appear exactly as physical storage attached to a port of the first switch. Thus, the first switch discovers the VLU as a physical LU at step 724. The first switch can now create a member from the VLU just as it would from physical storage actually connected at the switch.

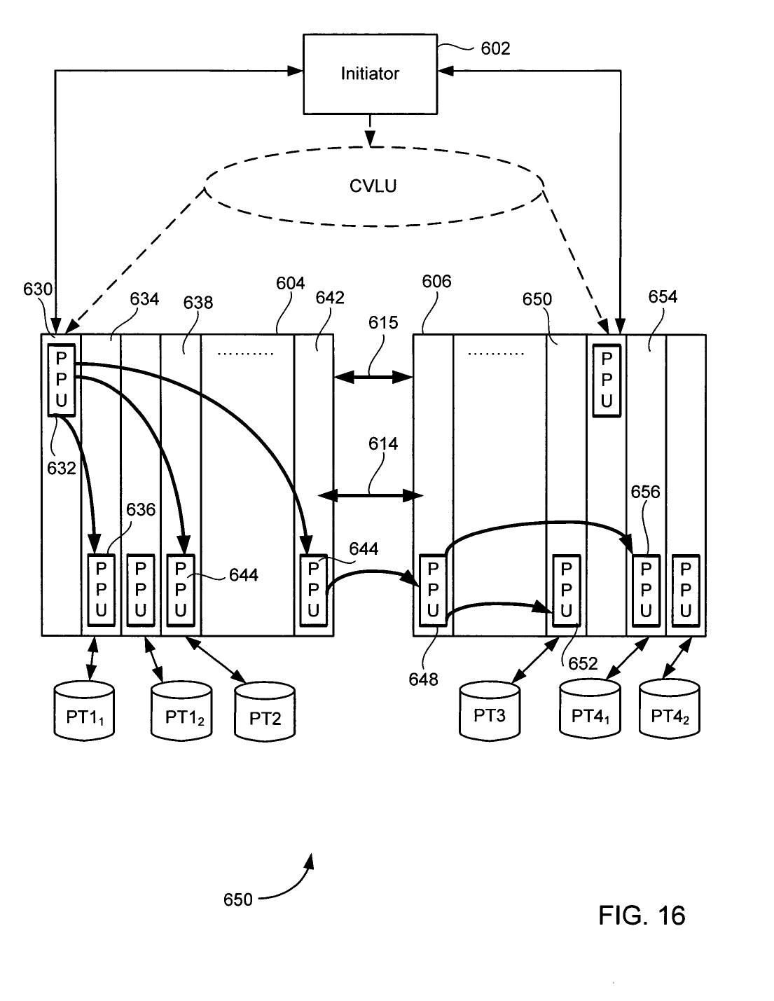

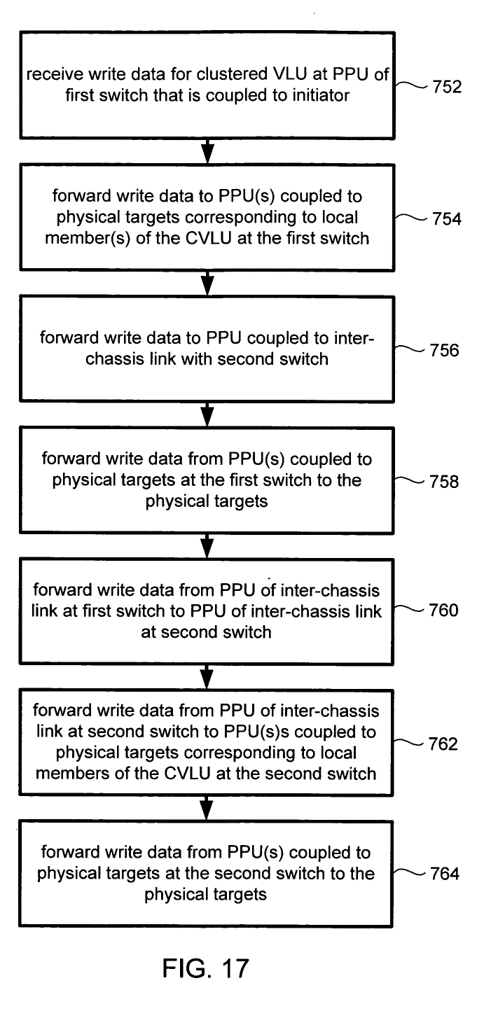

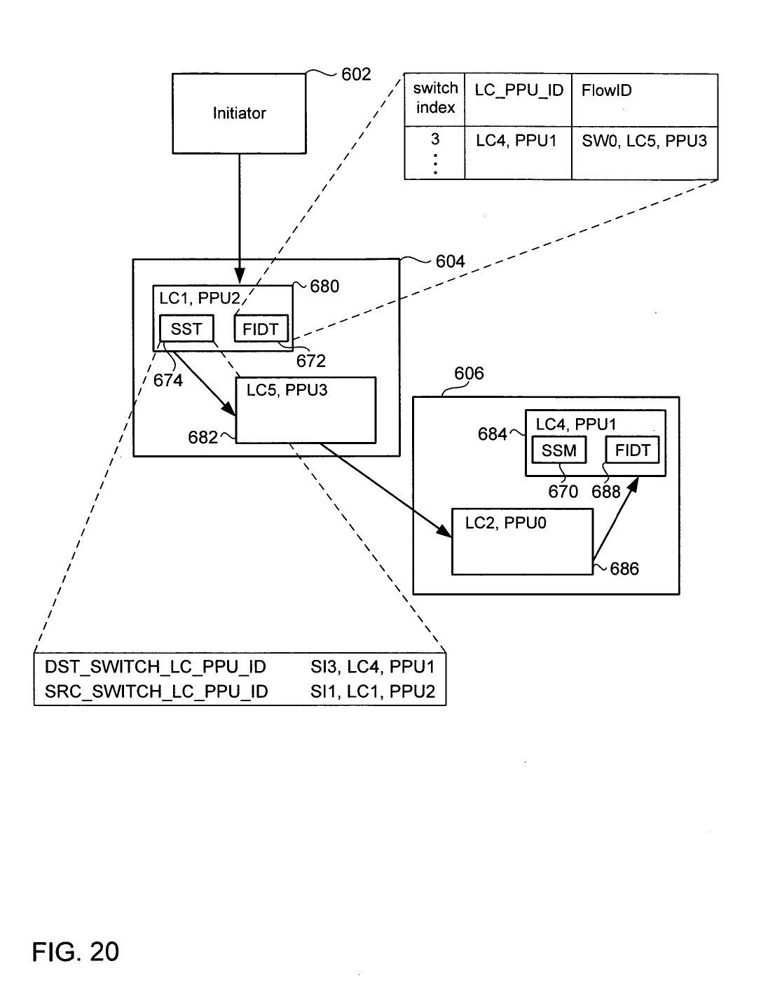

FIG. 16 is a block diagram depicting storage area network 650 in accordance with one embodiment. In FIG. 16, the line cards and packet processing units associated therewith are depicted to illustrate the data flow for a write operation to the mirrored CVLU. FIG. 17 is a flowchart depicting a method for writing data to a mirrored virtual logical unit across storage switches such as that depicted in FIG. 16. FIGS. 16 and 17 will be described concurrently, the method depicted in FIG. 17 being described with relation to the block diagram depicted in FIG. 16 for exemplary purposes. It will be appreciated that FIGS. 16 and 17 depict the data flow resulting from a processed write request. FIGS. 16 and 17 do not depict control messages between the switches (see FIGS. 20-22), the command flow for the write request, transfer ready resolution, or responses that would precede the actual transfer of data. More information regarding read and write request processing can be found in co-pending U.S. patent application Ser. No. 10/833,438.

At step 752, write data for a mirrored clustered VLU is received at a first storage switch. As depicted in FIG. 16, the write data is received from initiator 602 at storage switch 604. More specifically the write data is received at a line card 630 of storage switch 604. Line card 630 includes a packet processing unit 632. The packet processing unit can determine the corresponding members of the virtual logical unit to which the right data is destined (such as by accessing the VTD and Flow ID for VLU1₁) and forward the write data to the line cards and packet processing units coupled to the physical targets corresponding to the local members of the clustered virtual logical unit at switch 604. Local members as used herein refers to the members provisioned at a switch that correspond to physical targets physically connected to that switch. As depicted in FIG. 16 for step 754, PPU 632 forwards the write data to the packet processing units and line cards connected to the respective physical targets. In FIG. 16, the data at step 754 is forwarded to PPU 636 at line card 634 and PPU 640 at line card 638. At step 756, the ICL location is determined from a Flow ID for members M3₁ and M4₁ and the write data is forwarded to the packet processing unit and line card connected to the second storage switch across an inter chassis link. In FIG. 16, PPU 632 forwards the write data to PPU 644 at line card 642.

At step 758, the write data is forwarded from the PPUs of the line cards connected to the physical targets to the respective physical targets. For example, step 708 includes forwarding write data from PPU 636 to physical target PT1₁ and from PPU 640 to physical target PT2. At step 760, the write data is forwarded across the inter chassis link to the second storage switch. In FIG. 16, step 760 includes forwarding the write data from PPU 644, across inter chassis link 614, to PPU 648 at line card 646.

At step 762, the write data from the PPU at the inter chassis link of the second switch will forward the write data to the PPUs coupled to the physical targets corresponding to the local members of the virtual logical unit at the second switch. In FIG. 16, PPU 648 will forward the write data to PPU 652 and PPU 656. At step 764, the PPUs forward the data to the actual physical targets connected to the second storage switch. Thus, PPU 652 forwards the data to physical target PT3 and PPU 656 forwards the data to physical target PT4₂. Accordingly, by virtue of providing a mirrored clustered virtual logical unit which corresponds to virtual logical units provisioned at more than one storage switch, data is successfully routed to physical targets connected to more than one storage switch to provide high availability of the data stored thereon. The data can be routed in a cut through fashion at wire-speed without buffering of data within the switch. The data path to each physical target can be provisioned prior to issuing a transfer ready response to an initiating device. Because a local header containing all routing information can be added to incoming packets, the data is routed through the switch without buffering for intermediate processing.

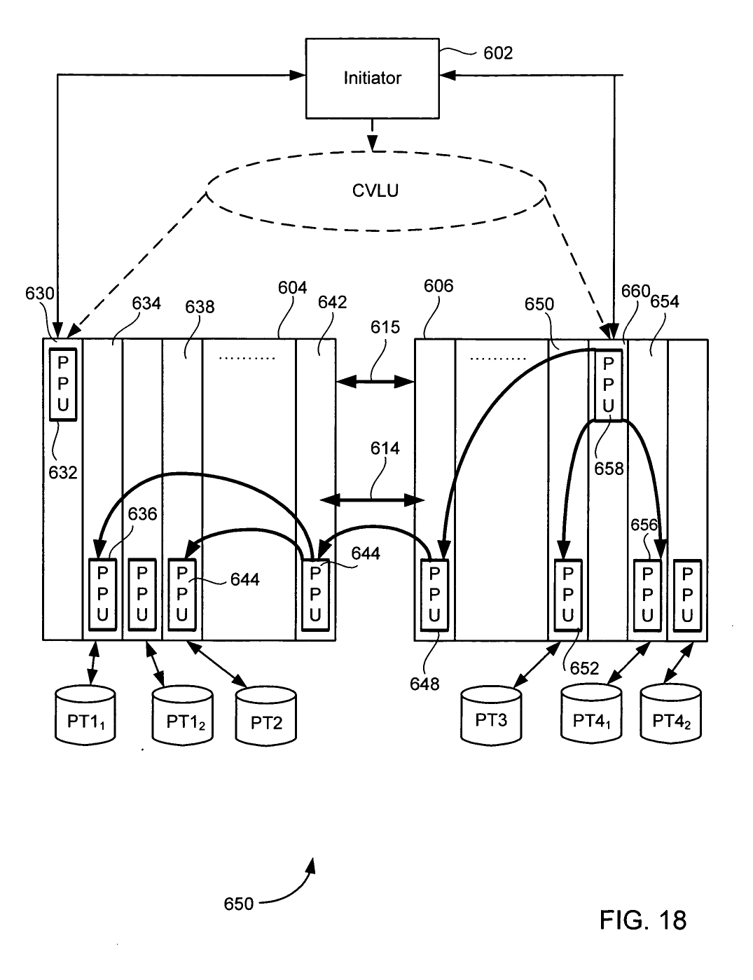

FIG. 18 is the block diagram of FIG. 16 depicting the data flow for a command received at switch 606 rather than switch 604. The write data for the mirrored clustered VLU is received at PPU 658 of linecard 660 at switch 606. PPU 658 can determine the corresponding members of the virtual logical unit to which the right data is destined (such as by accessing the VTD for VLU1₂). The Flow ID for each destination PPU connected to a local physical target can be determined from a Flow ID table provisioned at PPU 658 and the write data multicast to each of these line cards. The data can also be multicast to the line card of the ICL connection to switch 604, as determined from the Flow ID table. Accordingly, that data is multicast to PPU 656, PPU 652, and PPU 648. The write data is forwarded from the local PPUs to the local targets and from PPU 648 to PPU 644 at switch 604. PPU 644 accesses a VTD for VLU1₁ to determine the destination for the data. After accessing a Flow ID for each destination and updating header information, commands are forwarded to PPU 644, and PPU 636.

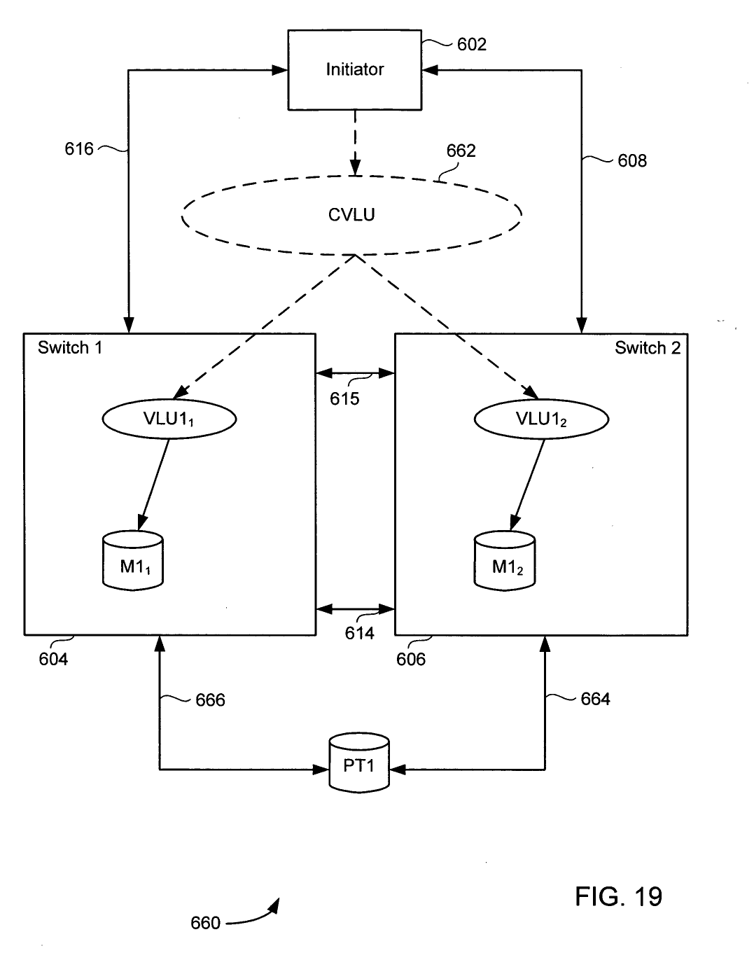

FIG. 19 is a block diagram of a storage area network in accordance with another embodiment for providing high availability of physical targets and data using multi-chassis, multi-pathing storage solutions. Storage area network 660 includes initiator 602, storage switch 604, storage switch 606 and physical target PT1. Physical target PT1 has a physical connection to both of switches 604 and 606. Many storage subsystems include multiple port capabilities to enable connections to multiple host devices or multiple connections to a single host device. This functionality is taken advantage of as depicted in FIG. 19 to provide a physical connection between the physical target and both of the storage switches.

VLU1₁ at storage switch 604 has been provisioned to include member M1₁, representing the virtualization of physical target PT1 at switch 604. Likewise VLU1₂ has been provisioned at switch 606 to include member M1₂, representing the virtualization of physical target PT1 at storage switch 606. As previously described, a clustered virtual logical unit 662 is created by assigning the same identification to both of VLU1₁ and VLU1₂. Accordingly, initiator 602 has multiple paths, 616 and 608, to CVLU 662 via VLU1₁ at switch 604 and VLU1₂ at switch 606. Although each of the paths are physically connected to different storage switches, and distinct virtual logical units are provisioned at each of the storage switches, each distinct virtual logical unit appears as a single clustered VLU virtual logical unit to initiator 602 by virtue of the identical identifications assigned to each of the virtual logical units. As previously described, initiator 602 can access PT1 via VLU1₁ at switch 604 and via VLU1₂ at switch 606.

In the configuration depicted in FIG. 19, high availability of physical target PT1 is provided by virtue of the clustered virtual logical unit and the multiple connections between the physical target and storage switches. For example, should connection 608 become unavailable, initiator 602 can access CVLU 662 (and the underlying physical target) via VLU1₁ at switch 604. Likewise, should path 616 become unavailable, initiator 602 can access CVLU 622 (and physical target PT1) via path 608 and VLU1₁ at storage switch 606.

Furthermore, because multiple paths are provided between the physical target and the storage switches, the loss of a storage switch will not affect the availability of the physical target to initiator 602. For example, if path 664 or storage switch 606 becomes unavailable, initiator 606 will have access to physical target PT1 and CVLU 662 via switch 604 and VLU1₁. Likewise, if path 666 or switch 604 becomes unavailable, initiator 602 will have access to physical target PT1 and CVLU 662 via switch 606 and VLU1₂.

Additionally, each VLU can be provisioned to provide best path availability to physical target PT1. For example, VLU1₁ can be provisioned to access physical target PT1 via path 666, provided directly from switch 604 to the physical target, if such path is available. However, to provide for an alternate path should path 666 become unavailable, VLU1₁ can be provisioned to include an alternate path across inter chassis link 614. Thus, should VLU1₁ receive a write or read command from initiator 602 on path 616, VLU1₁ can route the appropriate command data to member M1₁, across inter chassis link 614 to switch 606, where the data or command will be routed to PT1 via path 664. As apparent in the figure, multiple such paths are provided and can be taken advantage of to provide high availability of the physical target.

It will be apparent to those of ordinary skill in the art that the present disclosure is not limited to the numbers and exact configurations of the networks, physical targets, switches, and initiators depicted herein. For example, a virtual logical unit can be provisioned to include any number of members and each member can be provisioned to include any number of physical targets or portions thereof.

As mentioned previously, embodiments can include accessing physical targets over multiple switches including intervening switches. For example, a first switch can be connected to a second switch over an ICL, and the second switch can be connected to a third switch over an additional ICL. A VLU can be provisioned at the first storage switch to include a member corresponding to a physical target connected to the third storage switch. The VLU (via an associated VTD and Flow ID) at the first storage switch can reference the line card and port of the ICL at the first switch to provide a cut-through implementation for accessing the third switch and ultimately the physical target. The second switch, through a VTD and Flow ID provisioned at the second switch for the corresponding VLU, will add header information to packets to route the packets to the ICL connection at the second switch with the third switch. The packets received at the third switch have header information added as determined from the VTD and Flow ID for the VLU provisioned at that switch to route the packets to the line cards and ports connected to the actual physical targets.

Multiple ICLs can be provided amongst storage switches to provide even higher availability of data and physical targets. For example, a first member corresponding to a first physical target connected to a second storage switch can be provisioned at a first storage switch. The first member can be provisioned for access to the first physical target via the second storage switch across a first ICL. The member can further be provisioned to access the same first physical target across a second ICL to the second switch. A VTD for the virtual logical unit to which the member is provisioned can include a second Flow ID specifying routing information for the second ICL. If the first connection is unavailable, the internal virtual logical unit can route commands and data across the second ICL to the second storage switch. In one embodiment, a single Flow ID is used and code is provisioned to re-provision the Flow ID for the second connection if the first connection becomes unavailable. Multiple ICLs can be provisioned for redundancy to provide available paths should one or more other links become unavailable. Failover and failback mechanisms can be provided to increase availability of the underlying data and storage subsystems. A multiple inter-chassis link configuration can be used for load-sharing. Data can be routed across each link in a manner to distribute the load of each link to increase overall performance. Data can be routed more quickly by selectively routing data across one of the links.

A transaction-based messaging subsystem can be implemented on and between storage switches having related virtual logical units to maintain consistency between operations and manage incoming requests for a clustered virtual logical unit. For example, a storage services manager or module (SSM) can be implemented on each switch to relay information to remote switches regarding clustered virtual logical units. For example, requests for VLU1₁ or VLU1₂ in FIG. 12 in a CVLU configuration can be received and managed by the SSM in a transaction based messaging system. In one embodiment, a CVLU database is maintained within non-volatile memory at each switch. When a request is received for a VLU listed in the database, it can be determined that the request relates to a CVLU. Accordingly, the SSM can control processing of commands for and relay information to any remote switches associated with the CVLU to properly manage the interaction of each individual VLU. The messaging system can provide messages over ICL links(s) 614 in one embodiment or over an IP connection 615 in other embodiments. In one embodiment, the system can use an IP connection by default and use ICL link(s) 614 if the IP connection is unavailable.

In one embodiment, for example, when a write request is received for a CVLU, the switch receiving the request can provide a message to any remote switches that a request is being processed for the CVLU. The remote switches can then take appropriate action to ensure conflicting requests are not being processed at individual switches for the CVLU. For example, in one embodiment each remote switch will queue any incoming requests they receive for the CVLU after receiving a message that a request is being processed for the CVLU at another switch. The remote switches will continue to queue incoming requests until they receive a subsequent message that the request being processed has been completed. Upon receiving the subsequent message, the queued requests can be dequeued and processed in the order they were received. In one embodiment, each remote switch forwards incoming requests it receives to the switch providing the message that it is processing a request for the CVLU. The switch receiving the first command thus becomes the primary switch and it will queue all of the incoming requests at all switches while it processes the outstanding request. Upon completion, the primary switch will then dequeue the requests and process them.

FIG. 20 depicts a transaction based messaging subsystem that can be used to manage clustered virtual logical units provisioned across storage switches (the subsystem can also and at the same time manage non-clustered provisioned targets local to a single switch). Storage switches 604 and 606 are interconnected over one or more ICL links 614 and 615. A storage services module or instance (SSM) 670 is running on storage switch 606 at PPU1 684 on linecard 4 (LC4). Storage services module 670 can be a storage service instance provisioned for a specific virtual target. For example, the virtual target could be a clustered virtual logical unit having individual virtual logical units provisioned at each of switches 604 and 606, such as CVLU 620 of FIG. 13. There is no corresponding SSM at switch 604. Thus, the single storage service instance 670 controls storage services at both storage switches for the CVLU. A message passing architecture is implemented across both switches to facilitate such control involving a single storage services instance. Although the present example depicts two storage switches and a message passing architecture for the two switches, it will be appreciated that the present disclosure is not so limited and the disclosed principles and techniques can be applied to configurations including any number of switches.

In FIG. 20, control messages associated with commands received at storage switch 604 are forwarded to SSM 670 at storage switch 606. Initiator 602 can issue commands at LC1, PPU2 680 of switch 604 for VLU1₁. In response, control messages can be forwarded to SSM 670 such that SSM 670 controls access to and processing of I/O commands for CVLU 620. Accordingly, control commands are passed from LC1, PPU2 680 to LC5, PPU3 682, across an ICL link to LC2, PPU0 686 at switch 606, and onto SSM 670 at LC4, PPU1 684. For commands received at a linecard and PPU of storage switch 606, control messages can be passed to SSM 670 at PPU 684 using locally provisioned Flow IDs as previously and hereinafter described.

In order to facilitate the message passing architecture, a Flow ID table for PPU 680 is provisioned to include entries for every PPU in the multi-switch configuration. Each PPU of a switch has a unique Flow ID table that includes information for accessing every other PPU in the switch. In a simple single switch configuration, an index (e.g., a 6-bit LC_PPU_ID field) in a Flow ID table uniquely identifies each PPU at that switch by its number and the number of the linecard on which it is located. This technique is extended in a multi-switch configuration to identify every PPU at every interconnected switch. In FIG. 20, for example, Flow ID table (FITD) 672 for PPU 680 will include entries for each PPU at switches 604 and 606. In order to properly reference each PPU, a unique index used to identify each PPU includes a switch or chassis index in addition to an index identifying the PPU and linecard number. This switch index (SW index) can uniquely identify the switch on which the indexed PPU is physically located. Thus, the resulting index for each PPU will comprise a SWITCH index+LC_PPU_ID index.

The switch index and Flow ID table can be provisioned relative to the local switch such that a common index (e.g., 0) is always used to identify the local switch or switch of the PPU for which the Flow ID applies. For example, the Flow ID table provisioned for PPU 680 at switch 604 will identify each PPU at storage switch 604 with the same switch index, assumed to be 0 for the remainder of this example. For the Flow ID table provisioned at switch 604, the PPUs at switch 606 will be identified by some other identifier. Likewise, a Flow ID table provisioned at switch 606 will identify each PPU of switch 606 with a switch index of 0 to designate that they are at the local switch and each PPU of the other switches by some other identifier. In FIG. 20, it will be assumed that the index for switch 606 that is maintained at switch 604 is 3 and the index for switch 604 that is maintained at switch 606 is 1.

The Flow ID in the table for each PPU (local) having a switch index of 0 is provisioned as previously described for typical single switch routing functions. Accordingly, when a reference to the Flow ID table is made and the switch index for the destination PPU is 0, typical local routing using the Flow ID as previously described will be performed. For example, a command may be directly routed from an ingress PPU to the egress PPUs connected to the physical targets associated with the command.

The Flow ID in the table for each PPU of another switch, however, is provisioned to point to the PPU at the local switch that forms an ICL connection to the second switch. For example, an entry in Flow ID table 672 for PPU 684 at switch 606 will point to PPU 682 of switch 604 that forms the ICL connection to switch 606. An ICL port ID can also be provisioned and made accessible to the ICL PPU to identify the actual port number forming the ICL connection in embodiments where multiple ports are controlled by a single PPU.

If more than one ICL connection is provided, a Flow ID can reference the PPU of one connection by default. If failure of the ICL connection occurs, the Flow ID table can be re-provisioned to reflect the PPU for the redundant ICL connection. Multiple Flow IDs can be provisioned for a single destination PPU to reflect the different ICL connections that can be used to access the PPU. For example, a default Flow ID can be used and when the bandwidth exceeds a threshold value, new messages can be sent across another ICL connection by selecting the Flow ID for the other connection.

A storage service module such as SSM 670 can provision storage service tables (SST) for the virtual target to which the storage service module is associated. Storage services table 674 can include a first destination entry or field DST_SWITCH_LC_PPU_ID that identifies or points to PPU 684 on which SSM 670 is running at storage switch 606. The switch index for the entry identifies the switch at which the SSM is running by the index for that switch maintained at the current switch. Thus, continuing with our example, storage services table 674 at switch 604 will contain a DST_SWITCH_LC_PPU_ID field with a switch index of 3 and linecard and PPU index of LC4, PPU1. A second (source) entry (e.g., SRC_CHASSIS_LC_PPU_ID) can identify or point to the linecard and PPU for which the storage services table is provisioned. This source entry essentially points to itself. The switch index for the source entry will identify the switch index of the switch where the table is provisioned as maintained on the switch at which the SSM is running. Thus, in our example, SST 674 will contain a SRC_SWITCH_LC_PPU_ID field with a switch index of 1 and linecard and PPU index of LC1, PPU2.

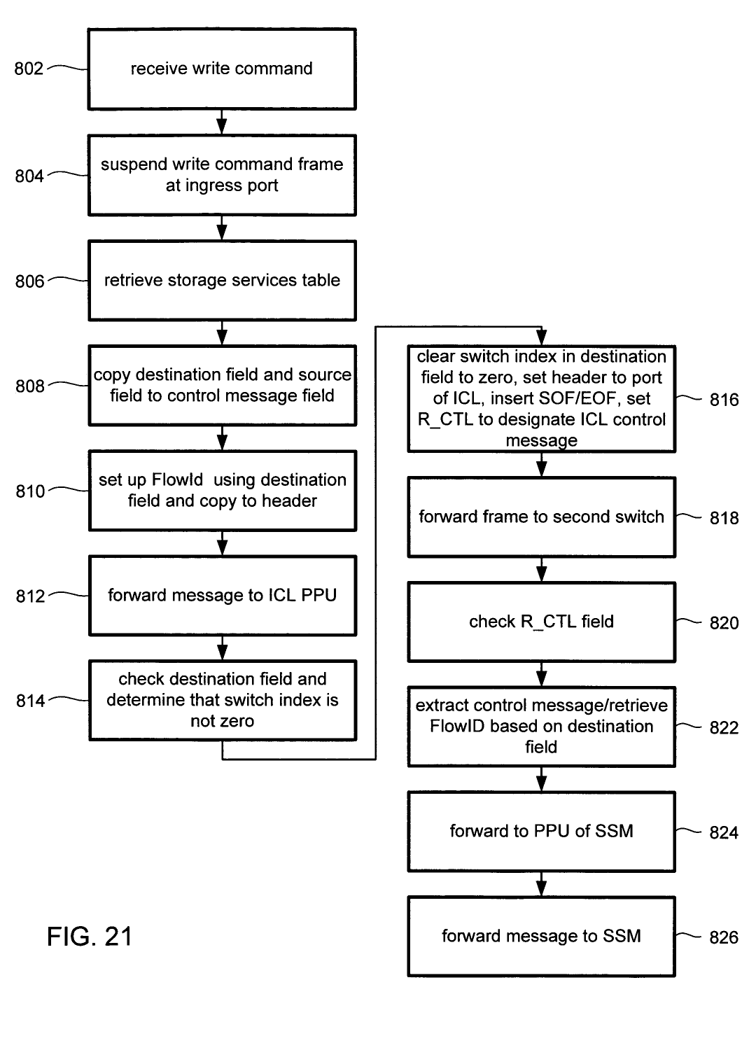

FIG. 21 is a flowchart for passing an exemplary control message across switches in accordance with one embodiment. A write command is received from initiator 602 at step 802, and suspended at step 804, such as by buffering in a first in/first out (FIFO) buffer at LC1. PPU2 at LC1 retrieves storage services table 674 at step 806. The table includes field DST_SWITCH_LC_PPU_ID set to switch index 3, LC4, PPU1 (switch 606, linecard 4, PPU 1) and field SRC_SWITCH_LC_PPU_ID set to switch index 1, LC1, PPU2 (switch 604, linecard 1, PPU 2). The values for each field are copied into the message at step 808. The Flow ID for the command is set up at step 810 based on the destination field. PPU2 accesses Flow ID table 672 and determines that the Flow ID for switch index 3, LC4, PPU1 points to switch index 0, LC5, PPU3 and the ICL port ID is fibre channel port A. PPU2 sets up a VIX header with the Flow ID information, adds it to the message and passes the message to LC5, PPU3 at step 812.

LC5, PPU3 receives the message, checks the destination field and determines that the switch index is 3 (not zero) at step 814. From the switch index, PPU3 determines that the message is to be forwarded out an ICL port. PPU3 clears the destination field to zero (so that when it arrives at switch 606 it will be designated for local processing and not message passing), sets the local header to identify port A as the destination port, inserts start of header and end of header indications, sets the R_CTL field of the header to indicate ICL control message processing, and puts the control message into the frame payload. The frame is forwarded from PPU 682 to PPU 686 (LC2, PPU0) at step 818. PPU 686 checks the R_CTL field and determines that the message is for ICL control message processing at step 820. PPU 686 extracts the control message and based on the destination field (DST_SWITCH_LC_PPU_ID), retrieves the Flow ID for switch 0, LC4, PPU1 (switch 0 because the Flow ID table is local for switch 606) at step 822. The Flow ID is added to a header for the control message and the message forwarded to PPU 684 at step 824. The message is received at PPU 686 at step 826 and forwarded to SSM 670.

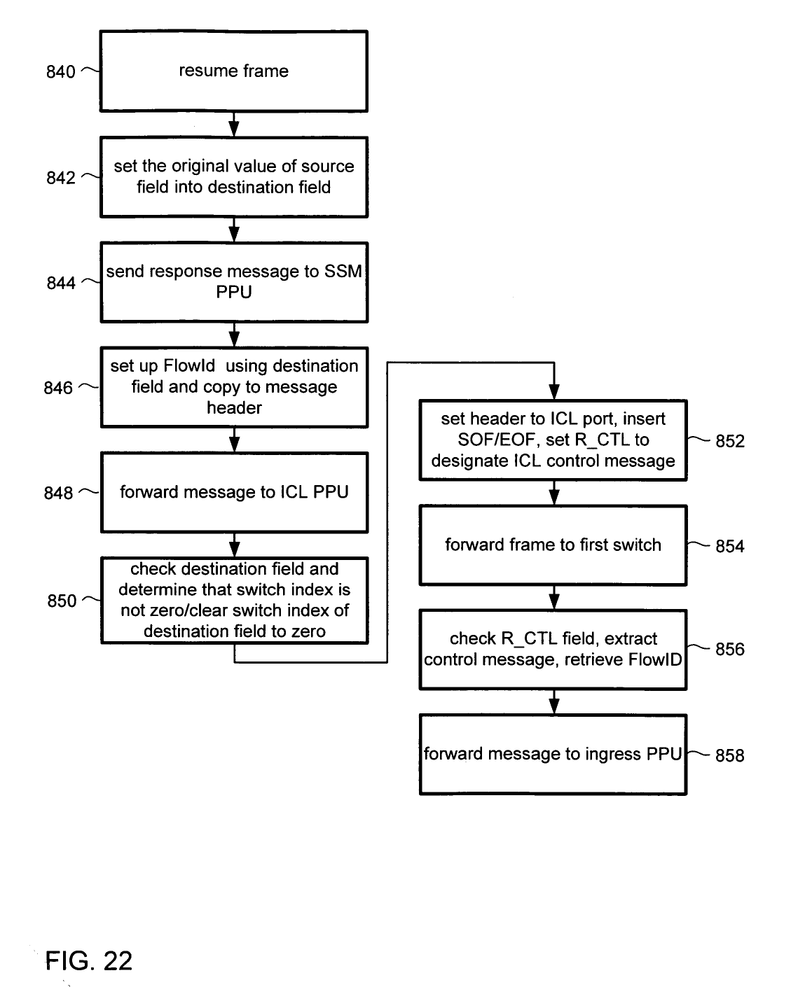

After processing the control message, SSM 670 passes a control message back to the source PPU. FIG. 22 is a flowchart for passing a response control message (resume message) back to a source PPU such as PPU 680 depicted in FIG. 20. An SSM can pass a resume message back to the PPU at which the write command is queued so that the write command can be processed.

SSM 670 resumes the frame (e.g., dequeues it from a buffer) at step 840. A control message is created and a destination field in the message set to the original source field (switch index 1, LC1, PPU2—switch index 1 is used to designate switch 604 at switch 606) at step 842. The control message is sent to PPU 684 at step 844. PPU 684 uses the destination field to retrieve the Flow ID for PPU 680 (switch index 1, LC1, PPU2) from Flow ID table 688. The Flow ID points to PPU 686 (switch index 0, LC2, PPU0). The Flow ID for the message is set up and inserted into a header for the message at step 846. PPU 684 forwards the message to PPU 686 at step 848. PPU 686 determines that the switch index is not zero and clears the destination field to zero (switch index 0, LC1, PPU2) in response at step 850. PPU 686 sets the local header to identify the ICL port, inserts start of header and end of header indications, sets the R_CTL field of the header to indicate ICL control message processing, and puts the control message into the frame payload at step 852.

The frame is forwarded to PPU 682 at step 854. PPU 682 checks the R_CTL field which is set to zero, extracts the control message, and retrieves the Flow ID for PPU 680 based on the destination field (switch index 0, LC1, PPU2) at step 856. The message is then forwarded to PPU 680 at step 858. After receiving the control message, PPU 680 can resume the write command received from initiator 602. If the command is for CVLU 620, the write command will be dequeued and processed by multicasting the write command to each of the PPUs connected to a physical target associated with the CVLU. After transfer ready management is performed, the data received from initiator 602 is multicast to the physical targets as depicted in FIG. 16.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto and their equivalents.

What is claimed is:

1. A storage switch for accessing virtual targets, comprising:
at least one virtual logical unit configuration including at least one member associated with at least one physical target coupled to a different storage switch; and
a communications link to said different storage switch.

2. The storage switch of claim 1, wherein:
said virtual logical unit configuration includes a virtual target descriptor identifying flow information to access said at least one physical target.

3. The storage switch of claim 2, wherein:
said communications link includes a first processing unit in communication with said different storage switch; and
said flow information identifies said first processing unit.

4. The storage switch of claim 2, wherein:
said flow information is a Flow ID.

5. The storage switch of claim 1, wherein:
said at least one physical target is at least one first physical target;
said at least one virtual logical unit configuration further includes a second member associated with at least one second physical target coupled to the storage switch.

6. The storage switch of claim 4, wherein:
said at least one virtual logical unit configuration is a mirrored virtual logical unit configuration; and
said at least one member and said second member are mirrored members of said mirrored virtual logical unit configuration.

7. The storage switch of claim 4, wherein:
said communications link includes a first port;
the storage switch further comprises a second port in communication with said at least one second physical target coupled to the storage switch; and
requests for said virtual logical unit configuration are routed to said first port and said second port.

8. The storage switch of claim 7, wherein:
said virtual logical unit configuration includes a virtual target descriptor identifying a processing unit for said first port and a processing unit for said second port.

9. The storage switch of claim 1, wherein:
said at least one virtual logical unit configuration comprises a portion of a clustered virtual logical unit configuration.

10. The storage switch of claim 1, wherein:
said communications link to said different storage switch includes a port coupled to a second storage switch, said second storage switch is coupled to said different storage switch.

11. The storage switch of claim 1, wherein:
said communications link communicates with said different storage switch over an inter-chassis link.

12. The storage switch of claim 1, wherein:
said communications link communicates with said different storage switch over a fibre-channel connection.

13. The storage switch of claim 1, wherein:
said communications link communicates with said different storage switch over an ethernet connection.

14. The storage switch of claim 1, wherein:
said communications link communicates with said different storage switch over an internet protocol connection.

15. The storage switch of claim 1, further comprising:
a memory storing said at least one virtual logical unit configuration.

16. The storage switch of claim 1, wherein:
said at least one member is at least one remote member.

17. A method of provisioning virtual targets, comprising:
provisioning at a first device a member corresponding to at least one physical target coupled to a second device; and
provisioning at said first device a virtual logical unit configuration including said first member.

18. The method of claim 17, wherein:
said member is a first member;
said at least one physical target coupled to said second device is at least one first physical target;
said method further comprises provisioning at said first device a second member corresponding to at least one second physical target coupled to the first device; and
said step of provisioning at said first device a virtual logical unit configuration includes provisioning said virtual logical unit configuration to include said second member.

19. The method of claim 18, wherein:
said virtual logical unit configuration is a mirrored virtual logical unit configuration; and
said first member and said second member are mirrored members of said mirrored virtual logical unit configuration.

20. The method of claim 18, wherein said step of provisioning said virtual logical unit configuration includes
provisioning a virtual target descriptor for said configuration, said virtual target descriptor identifying a location of said at least one second physical target at said first device and a location of a first processing unit at said first device in communication with said second device.

21. The method of claim 17, wherein:
said virtual logical unit configuration includes a virtual target descriptor identifying a location of a first processing unit at said first device in communication with said second device.

22. One or more processor readable storage devices having processor readable code embodied on said one or more processor readable storage devices, said processor readable code for programming one or more processors to perform a method comprising:
provisioning at a first device a member corresponding to at least one physical target coupled to a second device; and
provisioning at said first device a virtual logical unit configuration including said first member.

23. One or more processor readable storage devices according to claim 22, wherein:
said member is a first member;
said at least one physical target coupled to said second device is at least one first physical target;
said method further comprises provisioning at said first device a second member corresponding to at least one second physical target coupled to the first device; and
said step of provisioning at said first device a virtual logical unit configuration includes provisioning said virtual logical unit configuration to include said second member.

24. One or more processor readable storage devices according to claim 23, wherein:
said virtual logical unit configuration is a mirrored virtual logical unit configuration; and
said first member and said second member are mirrored members of said mirrored virtual logical unit configuration.

25. One or more processor readable storage devices according to claim 23, wherein said step of provisioning said virtual logical unit configuration includes:
provisioning a virtual target descriptor for said configuration, said virtual target descriptor identifying a location of a first processing unit at said first device in communication with said second device.

26. One or more processor readable storage devices according to claim 22, wherein:
said virtual logical unit configuration includes a virtual target descriptor identifying a location of a first processing unit at said first device in communication with said second device.

27. A system for accessing virtual targets, comprising:
a clustered virtual logical unit including at least one first virtual logical unit provisioned at a first storage switch and at least one second virtual logical unit provisioned at a second storage switch, said first virtual logical unit and said second virtual logical unit having a same logical unit identifier.

28. The system of claim 27, wherein:
said first virtual logical unit includes a first member associated with at least a first physical target coupled to said first storage switch; and
said second virtual logical unit includes a first remote member associated with said at least a first physical target coupled to said first storage switch.

29. The system of claim 28, wherein:
said first virtual logical unit includes a second remote member associated with at least a second physical target coupled to said second storage switch;
said second virtual logical unit includes a second member associated with said at least a second physical target coupled to said second storage switch.

30. The system of claim 29, wherein:
said first virtual logical unit is a mirrored virtual logical unit;
said first member and said second remote member are mirrored members of said first virtual logical unit;
said second virtual logical unit is a mirrored virtual logical unit; and
said first remote member and said second member are mirrored members of said second virtual logical unit.

31. The system of claim 27, further comprising:
a storage services manager at said second switch associated with said clustered virtual logical unit.

32. The system of claim 31, wherein:
said first storage switch provides a control message to said storage services manager when said first storage switch receives a request for said clustered virtual logical unit.

33. The system of claim 32, wherein:
said storage services manager manages processing of said request byu forwarding a response message to said first storage switch to begin processing said request.

34. The system of claim 32, wherein:
said first storage switch queues said request when sending said control message.

35. The system of claim 27, wherein:
said logical unit identifier is a virtual logical unit identification.

36. The system of claim 27, further comprising:
a communications link between said first storage switch and said second storage switch;
wherein requests for said at least one first virtual logical unit are provided to said second storage switch over said communications link;
wherein requests for said at least one second virtual logical unit are provided to said first storage switch over said communications link.

37. The system of claim 27, wherein:
said clustered virtual logical unit is a mirrored clustered virtual logical unit;
said at least one first virtual logical unit is a mirrored virtual logical unit;
said at least one second virtual logical unit is a mirrored virtual logical unit.

38. A method of accessing virtual targets, comprising:
provisioning a first virtual logical unit at a first storage switch;
associating said first virtual logical unit with a logical unit identifier;
provisioning a second virtual logical unit at a second storage switch; and
associating said second virtual logical unit with said logical unit identifier.

39. The method of claim 38, wherein:
said method further comprises:
provisioning at said first storage switch a first member corresponding to at least one physical target coupled to said first storage switch, and
provisioning at said second storage switch a first remote member corresponding to said at least one physical target;
said step of provisioning a first virtual logical unit includes provisioning said first member as a member of said first virtual logical unit; and
said step of provisioning a second virtual logical unit includes provisioning said first remote member as a member of said second virtual logical unit.

40. The method of claim 38, wherein:
said at least one physical target is at least one first physical target;
said method further comprises:
provisioning at said first storage switch a second remote member corresponding to at least one second physical target coupled to said second storage switch,
provisioning at said second storage switch a second member corresponding to said at least one second physical target;
said step of provisioning a first virtual logical unit includes provisioning said second remote member as a member of said first virtual logical unit; and
said step of provisioning a second virtual logical unit includes provisioning said second member as a member of said second virtual logical unit.

41. The method of claim 40, wherein:
said step of provisioning a first virtual logical unit includes provisioning said first virtual logical unit as a mirrored virtual logical unit having said first member and said second remote member as mirrored members;
said step of provisioning a second virtual logical unit includes provisioning said second virtual logical mirrored virtual logical unit having said first remote member and said second member as mirrored members.

42. The method of claim 41, wherein:
said steps of associating said first virtual logical unit with a logical unit identifier and associating said second virtual logical unit with said logical unit identifier include creating a mirrored clustered virtual logical unit.

43. The method of claim 38, wherein:
said steps of associating said first virtual logical unit with a logical unit identifier and associating said second virtual logical unit with said logical unit identifier include creating a clustered virtual logical unit.

44. One or more processor readable storage devices having processor readable code embodied on said one or more processor readable storage devices, said processor readable code for programming one or more processors to perform a method comprising:
provisioning a first virtual logical unit at a first storage switch;
associating said first virtual logical unit with a logical unit identifier;
provisioning a second virtual logical unit at a second storage switch; and
associating said second virtual logical unit with said logical unit identifier.

45. One or more processor readable storage devices according to claim 44, wherein:
said method further comprises:
provisioning at said first storage switch a first member corresponding to at least one physical target coupled to said first storage switch, and
provisioning at said second storage switch a first remote member corresponding to said at least one physical target;
said step of provisioning a first virtual logical unit includes provisioning said first member as a member of said first virtual logical unit; and
said step of provisioning a second virtual logical unit includes provisioning said first remote member as a member of said second virtual logical unit.

46. One or more processor readable storage devices according to claim 45, wherein:
said at least one physical target is at least one first physical target;
said method further comprises:
provisioning at said first storage switch a second remote member corresponding to at least one second physical target coupled to said second storage switch,
provisioning at said second storage switch a second member corresponding to said at least one second physical target;
said step of provisioning a first virtual logical unit includes provisioning said second remote member as a member of said first virtual logical unit; and
said step of provisioning a second virtual logical unit includes provisioning said second member as a member of said second virtual logical unit.

47. One or more processor readable storage devices according to claim 46, wherein:
said step of provisioning a first virtual logical unit includes provisioning said first virtual logical unit as a mirrored virtual logical unit having said first member and said second remote member as mirrored members;
said step of provisioning a second virtual logical unit includes provisioning said second virtual logical mirrored virtual logical unit having said first remote member and said second member as mirrored members.

48. One or more processor readable storage devices according to claim 47, wherein:
said steps of associating said first virtual logical unit with a logical unit identifier and associating said second virtual logical unit with said logical unit identifier include creating a mirrored clustered virtual logical unit.

49. One or more processor readable storage devices according to claim 44, wherein:
said steps of associating said first virtual logical unit with a logical unit identifier and associating said second virtual logical unit with said logical unit identifier include creating a clustered virtual logical unit.

50. A method of provisioning virtual targets, comprising:
provisioning at a first storage switch a first member corresponding to at least one physical target coupled to said first storage switch;
provisioning at a second storage switch a first remote member corresponding to said at least one physical target;
provisioning at said first storage switch a first virtual logic unit including said first member, said provisioning including associating a first logical unit identifier with said first virtual logic unit; and
provisioning at said second switch a second virtual logical unit including said first remote member, said provisioning including associating said first logical unit identifier with said second virtual logic unit.

51. The method of claim 50, wherein:
said steps of provisioning at said first storage switch a first virtual logical unit and provisioning at said second storage switch a second virtual logical unit include creating a clustered virtual logical unit comprised of said first virtual logical unit and said second virtual logical unit.

52. The method of claim 51, wherein:
said at least one physical target is at least one first physical targets;
said method further comprising:
provisioning at said first storage switch a second remote member corresponding to at least one second physical target coupled to said second storage switch;
provisioning at said second storage switch a second member corresponding to said at least one second physical target;
said step of provisioning at said first storage switch a first virtual logical unit includes provisioning said second remote member as a member of said first virtual logical unit; and
said step of provisioning at said second storage switch a second virtual logical unit includes provisioning said second member as a member of said second virtual logical unit.

53. The method of claim 52, wherein:
said step of provisioning at said first storage switch a first virtual logical unit includes provisioning said first virtual logical unit as a mirrored virtual logical unit having said first member and said second remote member as mirrored members; and
said step of provisioning at said second storage switch a second virtual logical unit includes provisioning said second virtual logical unit as a mirrored virtual logical unit having said first remote member and said second member as mirrored members.

54. The method of claim 52, wherein:
said steps of provisioning at said first storage switch a first virtual logical unit and provisioning at said second storage switch a second virtual logical unit include creating a mirrored clustered virtual logical unit comprised of said first virtual logical unit and said second virtual logical unit.
